(19) United States
(12) Patent Application Publication
(10) Pub. No.: US 2026/0319638 A1
(43) Pub. Date: Oct. 15, 2026

(54) INFORMATION PROCESSING SYSTEM, INFORMATION PROCESSING METHOD, AND TERMINAL APPARATUS

(71) Applicant: Genki Watanabe, Tokyo (JP)

(72) Inventor: Genki Watanabe, Tokyo (JP)

(73) Assignee: Ricoh Company, Ltd., Tokyo (JP)

(21) Appl. No.: 19/466,985

(22) Filed: Feb. 2, 2026

(30) Foreign Application Priority Data
Feb. 28, 2025 (JP) 2025-030966
Oct. 21, 2025 (JP) 2025-176883

(51) Int. Cl. G06F 3/0482; G06F 3/0483; G06F 40/35; H04L 51/02

(52) U.S. Cl. CPC G06F 3/0482; G06F 3/0483; G06F 40/35; H04L 51/02

(57) ABSTRACT

An information processing system includes an information processing apparatus and a terminal apparatus. The information processing apparatus executes at least one interactive AI, causes information for identifying a first interactive AI to be displayed on a user application screen, receives input of a message to the interactive AI, determines whether a second interactive AI that outputs a more appropriate response is present, switches the dialogue partner to the second interactive AI, causes an indication of the switch to be displayed, and transmits to the terminal apparatus web content data for displaying a first web page and a second web page. The information processing apparatus determines whether the second interactive AI is present in response to an HTTP request from the terminal apparatus, and transmits an HTTP response. The terminal apparatus executes the script, displays the first web page, transmits the request, receives the response, and displays the second web page.

### CROSS-REFERENCE TO RELATED APPLICATIONS

This patent application is based on and claims priority pursuant to 35 U.S.C. § 119(a) to Japanese Patent Application Nos. 2025-030966, filed on Feb. 28, 2025, and 2025-176883, filed on Oct. 21, 2025, in the Japan Patent Office, the entire disclosure of each of which is hereby incorporated by reference herein.

### BACKGROUND

### Technical Field

The present disclosure relates to an information processing system, an information processing method, and a terminal apparatus.

### Related Art

A computer system has been devised that automatically generates a response to a message such as a question from a user and outputs the response to interact with the user.

### SUMMARY

The present disclosure described herein provides an information processing system including an information processing apparatus and a terminal apparatus. The information processing apparatus includes first circuitry. The first circuitry executes at least one of multiple types of interactive artificial intelligences (Als) that interact with a user and have different roles. The first circuitry causes information to be displayed on a screen of an application used by the user, the information for identifying a first interactive AI as a dialogue partner for the user among the multiple types of interactive AIs. The first circuitry receives input of a message to the first interactive AI. The first circuitry determines whether a second interactive AI that outputs a response more appropriate than a response of the first interactive AI to the message is present among the multiple types of interactive AIs based on the message and application information of the application. The first circuitry switches the dialogue partner to the second interactive AI based on a determination that the second interactive AI is present. The first circuitry causes an indication of the switch to be displayed. The first circuitry transmits to the terminal apparatus web content data for displaying a first web page and a second web page. The first web page presents a screen for receiving the input of the message from the user and displays the information for identifying the first interactive AI. The second web page displays the indication of the switch. The web content data includes a script for causing the terminal apparatus to execute at least a process for transmitting the message input on the first web page to the information processing apparatus, and a process for displaying the second web page presenting a screen indicating the switch. The first circuitry determines whether the second interactive AI is present in response to a HyperText Transfer Protocol (HTTP) request. The HTTP request is transmitted from the terminal apparatus executing the script and includes the message input on the first web page displayed on the terminal apparatus based on the web content data. The first circuitry transmits to the terminal apparatus an HTTP response including information for displaying the indication of the switch, as a response to the HTTP request, based on a determination that the second interactive AI is present. The terminal apparatus includes second circuitry. The second circuitry executes the script, displays the first web page based on the executed script, transmits the HTTP request including the message input on the first web page to the information processing apparatus, receives the HTTP response including the information for displaying the indication of the switch, and displays the second web page presenting the screen indicating the indication of the switch, based on the executed script.

The present disclosure described herein provides an information processing method including first causing, receiving, first determining, switching, second causing, first transmitting, second determining, and second transmitting. The first causing includes causing information to be displayed on a screen of an application used by a user, the information for identifying a first interactive AI as a dialogue partner for the user among multiple types of interactive AIs that interact with the user and have different roles. The receiving includes receiving input of a message to the first interactive AI. The first determining includes determining whether a second interactive AI that outputs a response more appropriate than a response of the first interactive AI to the message is present among the multiple types of interactive AIs based on the message and application information of the application. The switching includes switching the dialogue partner to the second interactive AI based on a determination that the second interactive AI is present. The second causing includes causing an indication of the switching to be displayed. The first transmitting includes transmitting to a terminal apparatus web content data for displaying a first web page and a second web page. The first web page presents a screen for receiving the input of the message from the user and displays the information for identifying the first interactive AI. The second web page displays the indication of the switching. The web content data includes a script for causing the terminal apparatus to execute at least a process for transmitting the message input on the first web page to the information processing apparatus, and a process for displaying the second web page presenting a screen indicating the switching. The second determining includes determining whether the second interactive AI is present in response to an HTTP request. The HTTP request is transmitted from the terminal apparatus executing the script and includes the message input on the first web page displayed on the terminal apparatus based on the web content data. The second transmitting includes transmitting to the terminal apparatus an HTTP response including information for displaying the indication of the switching, as a response to the HTTP request, based on a determination that the second interactive AI is present.

The present disclosure described herein provides a terminal apparatus including circuitry. The circuitry displays, on a screen of an application used by a user, information for identifying a first interactive AI as a dialogue partner for the user among multiple types of interactive AIs that interact with the user and have different roles. The circuitry receives input of a message to the first interactive AI, determines whether a second interactive AI that outputs a response more appropriate than a response of the first interactive AI to the message is present among the multiple types of interactive AIs based on the message and application information of the application, switches the dialogue partner to the second interactive AI based on a determination that the second interactive AI is present, and displays an indication of the switch.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information processing system according to a first embodiment;

FIG. 2 is a diagram illustrating an application screen according to the first embodiment;

FIG. 3 is a block diagram illustrating a hardware configuration of an information processing apparatus according to the first embodiment;

FIG. 4 is a block diagram illustrating a functional configuration of the information processing system according to the first embodiment;

FIG. 5 is a table illustrating data stored in an agent information storage unit;

FIG. 6 is a table illustrating data stored in a history information storage unit;

FIG. 7 is a sequence diagram illustrating a procedure executed by the information processing system according to the first embodiment;

FIG. 8 is a diagram illustrating an interactive screen displayed at the start of interaction;

FIG. 9 is a diagram illustrating an interactive screen that includes display information for selecting a new execution agent;

FIG. 10 is a diagram illustrating an interactive screen that includes display information for selecting a new execution agent according to a modification;

FIG. 11 is a diagram illustrating an interactive screen allowing a user to select whether to switch an execution agent;

FIG. 12 is a diagram illustrating final response information;

FIG. 13 is a diagram illustrating an interactive screen indicating the switch of an execution agent;

FIG. 14 is a sequence diagram illustrating a procedure executed by an information processing system according to a second embodiment;

FIG. 15 is a diagram illustrating an interactive screen for switching an execution agent without allowing user selection;

FIG. 16 is a diagram illustrating a screen configuration for interaction on an application screen according to a modification;

FIG. 17 is a block diagram illustrating a functional configuration of a terminal apparatus according to a third embodiment;

FIG. 18 is a sequence diagram illustrating a procedure related to screen transition according to the third embodiment;

FIG. 19 is a diagram illustrating an execution agent selection screen;

FIG. 20 is a diagram illustrating an interactive screen after a message is input;

FIG. 21 is a diagram illustrating a screen indicating the switch of an execution agent according to the third embodiment;

FIG. 22 is a diagram illustrating a screen transition of an application screen according to a modification of the third embodiment; and

FIG. 23 is a block diagram illustrating a functional configuration of a terminal apparatus having the functions of an information processing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, identical or similar reference numerals denote identical or similar elements such as parts and materials having the same functions, and redundant descriptions thereof are omitted unless otherwise required.

Referring now to the drawings, embodiments of the present disclosure are described below.

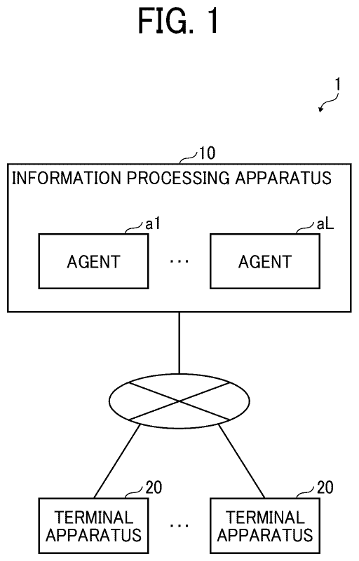

FIG. 1 is a diagram illustrating a configuration of an information processing system 1 according to a first embodiment. In FIG. 1, one or more terminal apparatuses 20 are connected to an information processing apparatus 10 via a network such as a local area network (LAN) or the Internet.

The information processing apparatus 10 is implemented by one or more computers that function as multiple types of agents a1 to aL that interact with a user. An agent is an example of interactive artificial intelligence (AI), and is an anthropomorphic virtual entity that appears to the user as a dialogue partner. The interaction with the interactive AI (dialogue partner) refers to that, when the user inputs a message, a response to the message is output. Specifically, the agent receives a message input by the user from the terminal apparatus 20 and outputs the response to the terminal apparatus 20. The message input by the user may be a question, an instruction, a request, or any other input information that requires a response. The response is text that includes information corresponding to the message. The text may be output by voice as the response to the message.

The agent may be referred to, for example, as automatic response means, an AI agent, a digital clone, a personalized AI, an AI assistant, an automatic response AI, a dialogue partner, an AI chatbot, a companion, a concierge, or a virtual interactive interface. The agent may be a virtual human displayed on the screen of the terminal apparatus 20 as a dialogue partner, for example, in the form of a three-dimensional (3D) avatar imitating a person.

The information processing apparatus 10 functions as multiple types of agents. The multiple types of agents are distinguished from each other by, for example, how to control generation of a response to a message. The multiple types of agents have roles that differ for each agent and are distinguished from each other according to their purpose or intended use. Examples of agent roles include inquiry (question and response), comparison, classification, prediction, document generation, document supplementation, and document evaluation.

Agents may be defined for each of these roles, or agents corresponding to other roles may be defined.

The user can select, as a dialogue partner, an agent that is suitable for the user's purpose or intended use from among the multiple types of agents. When the information processing apparatus 10 determines, according to the progress of the interaction, that one or more agents are present that can respond more suitably to a message from the user than the agent currently serving as the dialogue partner for the user, the information processing apparatus 10 presents to the user the one or more agents that are more suitable than the current agent. The information processing apparatus 10 can switch the agent serving as the dialogue partner to another agent selected by the user from among the presented agents.

The terminal apparatus 20 is an apparatus that operates as a user interface of the information processing system 1. For example, the terminal apparatus 20 may be implemented by a personal computer (PC), a smartphone, or a tablet terminal. The terminal apparatus 20 receives input of a message from the user and transmits the message to the information processing apparatus 10. The terminal apparatus 20 also receives a response generated in response to the message from the information processing apparatus 10 and displays the response. The terminal apparatus 20 may output the received response, for example, through a projector.

The selection of an execution agent to serve as the dialogue partner for the user and the interaction between the user and the agent are carried out by utilizing a partial area of the screen of an application that is launched on the terminal apparatus 20, that is, the application currently being used (operated) by the user. This screen of the application may be referred to as an “application screen” in the following description.

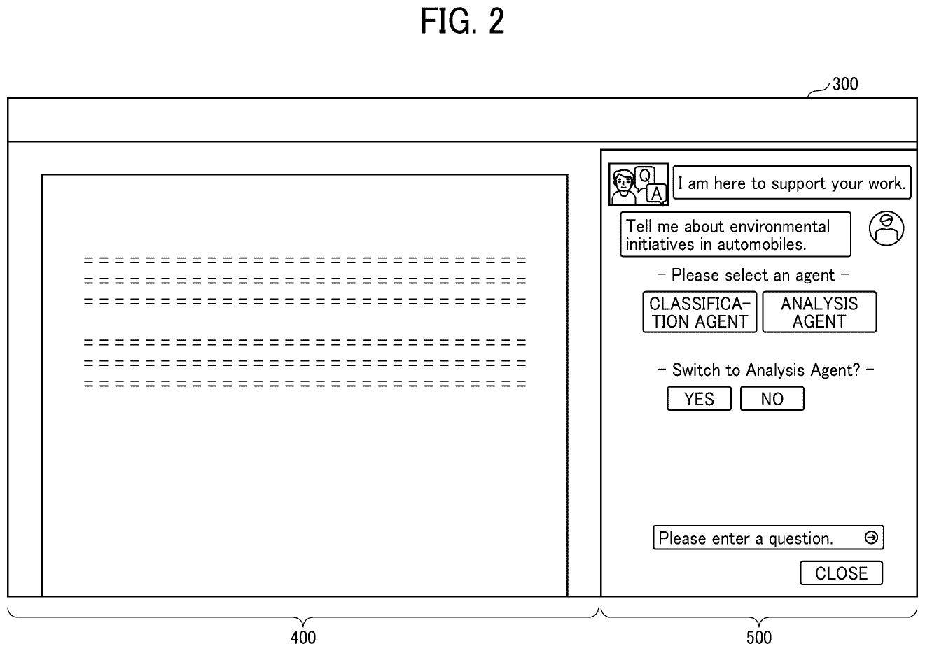

FIG. 2 is a diagram illustrating an application screen according to the first embodiment. In FIG. 2, an application screen 300 includes a content area 400 and an interactive area 500. The content area 400 is an area for displaying data (content) to be processed by an application. Examples of applications include a presentation creation application, a document creation application, a spreadsheet application, a web conferencing application, a viewer application for displaying portable document format (PDF) files and images, a web browser, and a web application displayed in the web browser. The content to be displayed in the content area 400 varies depending on the application and may include, for example, slides, documents, tables, video of a web conference, display files, web pages, and screens of web applications. The interactive area 500 is an area for the user to interact with the agent. For example, messages input by the user and responses from the agent are displayed in the interactive area 500. Although FIG. 2 illustrates a state in which the interaction has already progressed, a list of agents selectable as a dialogue partner is displayed at the start of the interaction, as will be described later. The display of the interactive area 500 may be implemented by an add-in to an application (an add-in to a web application when the web application is displayed in a web browser). FIG. 1 illustrates a system configuration in which the terminal apparatus 20 and the information processing apparatus 10 communicate with each other via a network as illustrated in FIG. 1; however, the present disclosure is not limited thereto. For example, the web conferencing application is often executed by communicating with a web conferencing application server. In this case, the terminal apparatus 20 communicates with the web conferencing application server and the information processing apparatus 10. The same applies to the case of a web browser. Specifically, the terminal apparatus 20 communicates with an application server that supports execution of an application of the terminal apparatus 20, such as a web conferencing application server, different from the information processing apparatus 10, and the information processing apparatus 10. The terminal apparatus 20 may communicate with the application server alone without communicating with the information processing apparatus 10, and the application server may communicate with the information processing apparatus 10 to display the screen as illustrated in FIG. 2 and interact with the interactive AI, thus implementing the present disclosure. The application server and the information processing apparatus 10 may be integrated and communicate with the terminal apparatus 20.

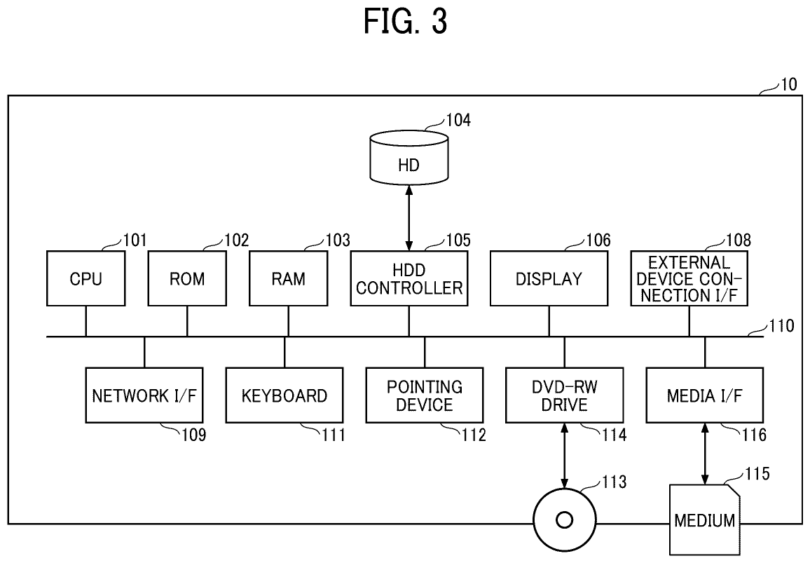

In the present embodiment, it is assumed that the information processing system 1 is operated by a certain company, which may be referred to as a “company X” in the following description. The user who can access the information processing apparatus 10 is a person belonging to the company X, such as an employee of the company X. The service provided by the information processing apparatus 10 may be open to the public as a cloud service. FIG. 3 is a block diagram illustrating a hardware configuration of the information processing apparatus 10 according to the first embodiment. As illustrated in FIG. 3, the information processing apparatus 10 is implemented by a computer, and includes a central processing unit (CPU) 101, a read-only memory (ROM) 102, a random-access memory (RAM) 103, a hard disk (HD) 104, a hard disk drive (HDD) controller 105, a display 106, an external device connection interface (I/F) 108, a network I/F 109, a data bus 110, a keyboard 111, a pointing device 112, a digital versatile disk rewritable (DVD-RW) drive 114, and a media I/F 116.

The CPU 101 controls the overall operation of the information processing apparatus 10. The ROM 102 stores a program such as an initial program loader (IPL) used for booting the CPU 101. The RAM 103 is used as a work area for the CPU 101. The HD 104 stores various data such as a program. The HDD controller 105 controls the reading of various data from, or the writing of various data to, the HD 104 under the control of the CPU 101. The display 106 displays various types of information, such as a cursor, a menu, a window, text, or an image. The external device connection I/F 108 is an interface for connection with various external devices. Examples of the external devices in this case include, but are not limited to, a universal serial bus (USB) memory and a printer. The network I/F 109 is an interface for data communication through a communication network. The data bus 110 is, for example, an address bus or a data bus that electrically connects the components such as the CPU 101.

The keyboard 111 is an example of an input device provided with multiple keys used for inputting characters, numerical values, and various instructions. The pointing device 112 is an example of an input device that allows selection or execution of various instructions, selection of a processing target, and movement of a cursor. The DVD-RW drive 114 controls the reading of various data from, or the writing of various data to, a DVD-RW 113, which is an example of a removable recording medium. The removable recording medium is not limited to a DVD-RW and may be, for example, a digital versatile disc recordable (DVD-R). The media I/F 116 controls the reading of data from, or the writing (storing) of data to (in), a recording medium 115 such as a flash memory.

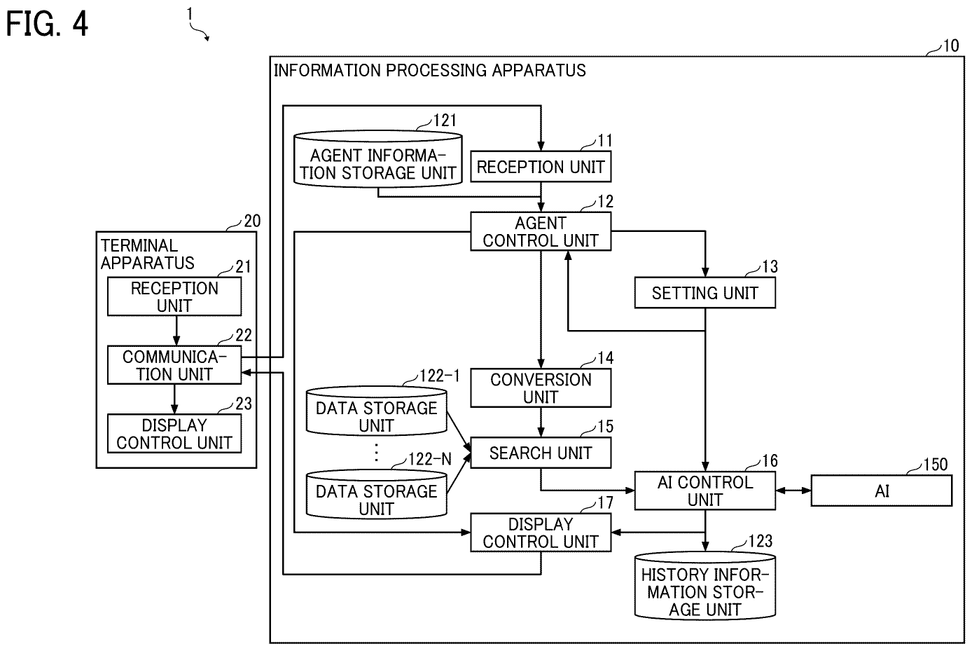

FIG. 4 is a block diagram illustrating a functional configuration of the information processing system 1 according to the first embodiment. The information processing apparatus 10 illustrated in FIG. 4 includes an AI 150 and an agent.

The AI 150 is a machine learning model (e.g., a neural network) trained to generate text (“response”) based on input text (“prompt”). The AI 150 may be trained to output a response including an image or a file. For example, the AI 150 generates, as a response to the prompt, text having the highest occurrence probability based on the learning result. The AI 150 may be, for example, a generative AI using a large language model (LLM). The LLM is a machine learning model that has learned natural language processing using a large amount of text data. The LLM is used in many natural language processing (NLP) tasks, such as generation of responses to specific questions, automatic generation of sentences, summarization of text, translation, and emotion analysis. Further, the LLM may be used in various fields such as education, entertainment, customer service, and product development. In the present embodiment, the text including a message input by the user serves as the prompt. The AI 150 does not have to be operated on the information processing apparatus 10. For example, the AI 150 may be a generative AI that is open to the public, such as the one available on the Internet. The AI 150 generates a response as an agent. The AI 150 may be provided for each of multiple types of agents. In such a case, when a first agent is selected by the user, a first AI corresponding to the first agent is controlled to generate a response to the message from the user, and when a second agent is selected, a second AI corresponding to the second agent is controlled to generate a response to the message from the user.

Machine learning is a technology for enabling computers to acquire human-like learning capabilities, and refers to a technique in which a computer autonomously generates algorithms necessary for decision-making, such as data classification, based on preloaded training data, and applies the generated algorithms to new data for prediction. The training methods for machine learning may include supervised learning, unsupervised learning, semi-supervised learning, reinforcement learning, deep learning, or any combination thereof, and the specific training method used for machine learning is not limited.

The agent is a set of functional units that: receive a message from the user; use retrieval-augmented generation (RAG) to enable the AI 150 to generate a response to the message; and execute processing to include in the prompt text previously generated by the AI 150 (i.e., responses output by the AI 150 to prompts previously input to the AI 150). Specifically, the agent includes, as such functional units, a reception unit 11, an agent control unit 12, a setting unit 13, a conversion unit 14, a search unit 15, an AI control unit 16, and a display control unit 17. Each of these functional units is implemented by processing executed by the CPU 101 according to one or more programs installed in the information processing apparatus 10. The agent also uses, as storage units, an agent information storage unit 121, multiple data storage units 122-1 to 122-N, and a history information storage unit 123. Any of the data storage units 122-1 to 122-N may be referred to collectively as “data storage units 122” or individually as “data storage unit 122” in the following description. Each of these storage units may be implemented by, for example, the HD 104 or a storage device that is connectable to the information processing apparatus 10 via a network.

While the information processing apparatus 10 functions as the multiple types of agents a1 to aL in the present embodiment, a program that functions as an agent is common to the agents. This program may be referred to as an “agent program” in the following description. The agent program causes the information processing apparatus 10 to function as the multiple types of agents based on information preset for each agent, which may be referred to as “agent information” in the following description.

The reception unit 11 receives input from the user. For example, the reception unit 11 receives from the user a selection of an agent, among the multiple types of agents a1 to aL, to serve as a dialogue partner. The agent serving as a dialogue partner may be referred to as an “execution agent” in the following description. The reception unit 11 also receives input of a message to the agent serving as the dialogue partner. On the screen of the application used by the user, the message to the agent serving as the dialogue partner is received. Further, the reception unit 11 receives information on an application corresponding to the application screen 300 including the interactive area 500 in which the message is input, and receives application information that is information on the application. In short, information related to the application used by the user is received. The application information is an example of application identification information for identifying an application itself, such as an application name, and is an example of type identification information for identifying the type of an application, and is information indicating what type of application the application is. The type of application refers to the type of each function when the application is classified by function, such as presentation creation, document creation, spreadsheet, web conference, content browsing or web browsing. For a web application, a uniform resource locator (URL) of the web application may be the application information. More specifically, the user performs the input on the terminal apparatus 20. The reception unit 11 thus receives information corresponding to the input, which is received by the terminal apparatus 20, from the terminal apparatus 20.

The agent control unit 12 controls switching of the execution agent. When the agent a1 is selected by the user as the execution agent, the agent control unit 12 executes a process to determine the selected agent a1 as the execution agent. When the execution agent is switched based on the progress of the interaction, the agent control unit 12 functions as an example of a determination unit that determines whether one or more agents (second interactive AIs) that can output a response more appropriate than that of the agent a1 (first interactive AI), which is the current execution agent (dialogue partner), to the message received by the reception unit 11 are present among the multiple types of agents a2 to aL. At this time, the agent control unit 12 determines whether one or more agents that can output a more appropriate response are present based on the application information together with the message. In other words, the agent control unit 12 determines whether one or more of the agents (second interactive AIs) that can output a response more appropriate than that of the execution agent (first interactive AI) are present, in consideration of the application information. The agent control unit 12 determines whether one or more agents (second interactive AIs) that can output a response more appropriate than that of the execution agent (first interactive AI) and that are related to application information are present. The agent control unit 12 functions as an example of a switching unit that switches the dialogue partner to the agent a2 (the second interactive AI) selected from among the one or more agents, based on a determination that the one or more agents are present. In a process of switching a certain agent to the execution agent, the agent control unit 12 inputs, to the setting unit 13, agent information of the execution agent from among the agent information stored in the agent information storage unit 121 for each agent. When the execution agent is switched in accordance with the progress of the interaction, the agent control unit 12 executes a process of switching the execution agent, based on the agent information stored in the agent information storage unit 121 for each agent and the message from the user.

Agent information of a certain agent among the agent information stored for each agent includes text information indicating the role of the agent, identification information of the data storage unit 122 corresponding to the agent, a system prompt corresponding to the agent, and a control rule corresponding to the agent. This identification information may be referred to as a “data source identification (ID)” in the following description.

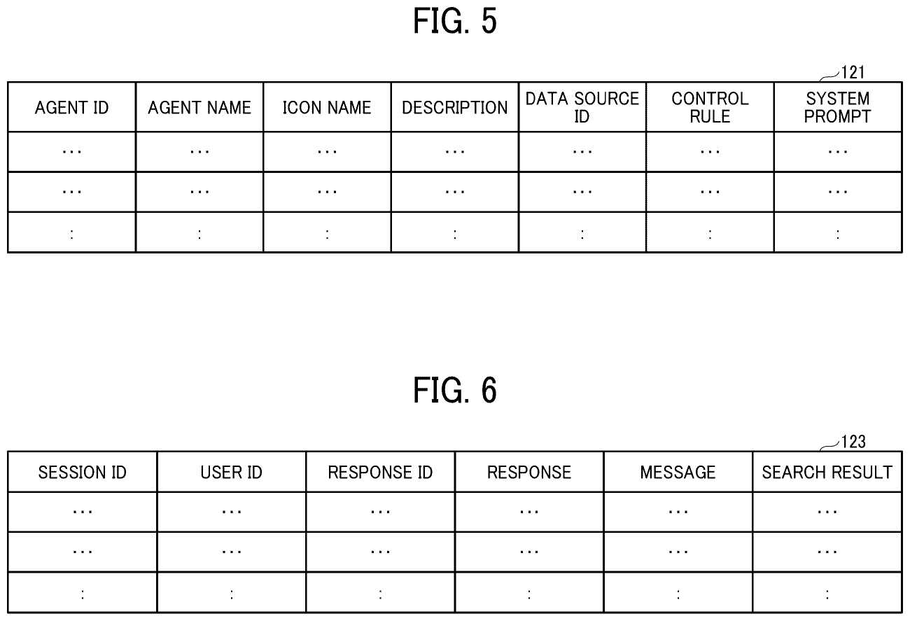

FIG. 5 is a table illustrating data stored in the agent information storage unit 121. As illustrated in FIG. 5, the agent information storage unit 121 stores in advance agent information including an agent ID, an agent name, an icon name, a description, a data source ID, a control rule, and a system prompt for each agent to be a selection candidate.

The agent name refers to the name of an agent. The icon name refers to the file name of an icon representing the agent. The icon is displayed on an interactive screen, which is a screen for interaction between the user and the agent. The description refers to text data describing, for example, the role of the agent in natural language. The data source ID refers to identification information of the data storage unit 122 to be searched by the agent. Two or more data storage units 122 may be searched. The control rule and the system prompt refer to a control rule and a system prompt for causing the AI control unit 16 to correspond to the agent. Since the control rule and the system prompt are defined for each agent, multiple types of control rules and system prompts different from each other are prepared in advance. When multiple agents search the same data source, applying distinct control rules to each agent enables generation of agent-specific responses that differ from one another. In other words, the role of the agent is implemented by the control rule and the system prompt. For example, in the case of an inquiry agent having a role of outputting an inquiry answer for answering an inquiry (question) from the user, a description describing such a role, and a control rule and a system prompt for controlling the agent in such a manner are stored in association with the inquiry agent. In the case of an analysis agent having a role of analyzing data in response to an instruction from the user and outputting an analysis result, a description describing such a role, and a control rule and a system prompt for controlling the agent in such a manner are stored in association with the analysis agent.

The system prompt is a template (form) of a prompt that is prepared in advance for each agent (for each role) and that is input into the AI 150. For example, the prompt to be input into the AI 150 is generated by inserting the message received by the reception unit 11 to the system template.

The control rule is data defining a procedure of input into and output from the AI 150, that is, a procedure of interaction with the AI 150, and is prepared in advance for each agent (for each role). To acquire a response to a certain message input by the user according to the role of the execution agent, a single input of a prompt to the AI 150 is insufficient, and it may be desirable to cause the AI 150 to execute multiple tasks, such as extraction and categorization of specific information, prediction, and loop processing. In this case, a prompt is to be input for each task. The control rule is data defining information indicating what kind of prompts are to be input to the AI 150 in what order (that is, the procedure of interaction with the AI 150). In the following description, the interaction with the AI 150 based on one control rule may be referred to as a “control procedure” whereas a single input of a prompt to the AI 150 in the control procedure may be referred to as a “phase.” When the control procedure includes multiple phases, a system prompt corresponding to each phase is prepared. In this case, the message received by the reception unit 11 may be inserted into the system prompt of a certain phase. The system prompts of other phases may be filled with responses acquired prior to the phase in the control procedure. For the purpose of distinguishing between a response acquired from the AI 150 in the middle of the control procedure and a response finally acquired from the AI 150 in the control procedure (that is, a response to a message from the user), the former may be referred to as an “intermediate response” and the latter may be referred to as a “final response” in the following description.

When a prompt is to be input once in the control procedure, the control rule includes one phase, and the number of system prompts is one. In this case, the final response is acquired for a single prompt input, without an intermediate response.

The setting unit 13 sets the AI control unit 16 and the search unit 15 to execute behaviors corresponding to the role of the execution agent, based on the agent information of the execution agent input from the agent control unit 12. The switching of the execution agent is implemented by switching the settings on the AI control unit 16 and the search unit 15. The setting of the AI control unit 16 is switched for each agent because the system prompt and the control rule differ for each agent. In other words, the system prompt and the control rule included in the agent information of the execution agent is set on the AI control unit 16. By contrast, the setting on the search unit 15 is switched for each agent because the data storage unit 122 to be searched (from which document data is acquired) may differ for each agent. For example, the agent a3 related to legal knowledge searches the data storage unit 122 storing document data related to law, and the agent a4 related to accounting knowledge searches the data storage unit 122 storing document data related to accounting. The search unit 15 is set with the data source ID included in the agent information of the execution agent.

When the reception unit 11 receives a message, the conversion unit 14 converts the message into a vector that represents the meaning of the message by a multi-dimensional numerical value. This vector may be referred to as a “semantic vector” in the following description. The semantic vector may be generated using a natural language processing model, such as bidirectional encoder representations from transformers (BERT). The semantic vector that is generated by converting the message may be referred to as a “message vector” in the following description.

The search unit 15 uses the message vector generated by the conversion unit 14 to extract document data having a relatively high relevance to the message from among document data items stored in the data storage unit 122 corresponding to the data source ID set by the setting unit 13. In other words, the data storage unit 122 to be searched (from which document data is acquired) by the search unit 15 changes depending on the setting made by the setting unit 13.

Document data related to various types of operations of the company X is stored (registered) in advance in each data storage unit 122. However, each data storage unit 122 stores a different set of document data. This is because the document data to be acquired differs depending on the role of the agent. Thus, the data storage unit 122 may be prepared for each agent. Some or all of the data storage units 122 used by two or more agents may be the same. The document data may be registered in each data storage unit 122 in a batch manner, or the user may upload the document data at any desired timing. Each data storage unit 122 stores, for each document data registered in the data storage unit 122, the document data and a semantic vector for each chunk of the document data. The chunk of document data refers to a portion of the document data obtained by dividing the document data into predetermined units. The unit for dividing the document data may be based on the number of characters, the number of sentences, or a semantic unit (for example, a paragraph). The document data may be pre-divided into such units and stored. The semantic vector of each chunk may be referred to as a “chunk vector” in the following description. The search unit 15 compares, for each document data stored in the data storage unit 122 being searched, the message vector with the chunk vector of each chunk associated with the document data, and identifies a chunk corresponding to a chunk vector having the highest similarity with respect to the document data. The search unit 15 compares the similarity of the similar chunk for each document data and extracts the top M similar chunks in terms of similarity. As a result, M document data items are substantially extracted. To evaluate the similarity between the vectors, a cosine similarity may be used, or another index may be used. The search unit 15 includes, in a search result, related document information including the top M similar chunks, chunk IDs stored in the data storage unit 122 in association with the similar chunks, and document IDs and file names stored in the data storage unit 122 in association with document data to which the similar chunks belong. The file names may be referred to as “document names” in the following description. Each data storage unit 122 may be managed based on a folder, a database, or any other management unit of a set of document data.

The AI control unit 16 generates a prompt by inserting the message received by the reception unit 11 and the set of similar chunks related to the search result by the search unit 15 into the system prompt set by the setting unit 13. In other words, the AI control unit 16 generates a prompt by augmenting the message received by the reception unit 11 with the set of similar chunks related to the search result by the search unit 15. Typical RAG may be used as a method for including the set of similar chunks related to the search result in the prompt. Text of each chunk belonging to the set of similar chunks related to the search result may be included in the prompt. Alternatively, a vector generated based on the chunk vector of the chunk may be included in the prompt. The following is a simple example of the system prompt.

<Example of system prompt begins.>
The message from the user is as follows:
{Message}
Please generate a response to the message by referring to the following documents.
{Set of similar chunks related to search result}
<Example of system prompt ends.>

As described above, the system prompt includes explicitly defined sections for inserting a message and for inserting a set of similar chunks related to the search result by the search unit 15. In this case, the AI control unit 16 generates a prompt by inserting the message received by the reception unit 11 to the {message} section of the system prompt and inserting the set of similar chunks related to the search result by the search unit 15 to the {set of similar chunks related to search result} section of the system prompt. Inputting the prompt thus generated to the AI 150 allows the AI 150 to generate a response based on even the information included in the set of similar chunks related to the search result, which includes information that the AI 150 has not learned. In other words, the response from the AI 150 may be based on the set of similar chunks related to the search result. The system prompt may include a character string for notifying the AI 150 of the role of an agent corresponding to the system prompt, such as “You are XXX.” (where XXX is a character string indicating the role).

When the control procedure includes multiple phases, a system prompt may be defined that explicitly specifies a section where an intermediate response acquired in a phase preceding a given phase is to be inserted. The intermediate response refers to, for example, an intermediate response acquired in any of the phases from the first phase to the (K−1)-th phase with respect to the K-th phase.

The AI control unit 16 also performs interaction with the AI 150 in the control procedure according to the control rule set by the setting unit 13. For each phase of the control procedure, the AI control unit 16 generates a prompt based on the system prompt corresponding to the phase, transmits the prompt to the AI 150, and receives a response to the prompt from the AI 150.

Further, each time the final response is acquired from the AI 150, the AI control unit 16 stores, in the history information storage unit 123, the final response in association with the message and the search result based on which the final response is acquired. The intermediate response may also be stored in association with the final response. Accordingly, history information of interaction between a user and an agent, that is, input into and output from the AI 150, is stored in the history information storage unit 123.

FIG. 6 is a table illustrating data stored in the history information storage unit 123. As illustrated in FIG. 6, the history information storage unit 123 stores, for each final response from the AI 150, history information including a session ID, a user ID, a response ID, a message, and a search result. The session ID refers to an ID unique to each session. The session refers to a series of interactions between the user and the agent from when an interactive screen 510 is displayed to when the interactive screen 510 is closed, including messages and the final response, and optionally intermediate responses. The same session ID is assigned to the final responses output in the same session. The user ID refers to identification information of a user who has performed a session (interaction) related to the session ID. The user ID may be identified as a result of user authentication. The response ID refers to, for example, an ID unique to each final response and is assigned by the AI control unit 16 when, for example, recording the final response in the history information storage unit 123. The message and the search result are a message and a search result applied to the prompt based on which the final response is acquired.

The display control unit 17 causes an identifiable indication of an agent serving as a dialogue partner for the user to be displayed on the screen of the application (application screen 300) used by the user. Specifically, the display control unit 17 transmits display content to the terminal apparatus 20 to cause the display content to be displayed in the interactive area 500 of the application screen 300. The terminal apparatus 20 displays, for example, an interactive screen in the interactive area 500 based on the display content. The display control unit 17 further causes final response information including the final response received by the AI control unit 16 to be displayed on the terminal apparatus 20 from which the message is transmitted. The final response information includes the final response and information indicating document data to which each similar chunk related to the search result by the search unit 15 belongs. Accordingly, the user can confirm what document data is used as a basis for generating the response.

When the agent control unit 12 determines that one or more agents that can output a response more appropriate than that of the execution agent are present, the display control unit 17 displays the one or more agents as selectable on the terminal apparatus 20. When the execution agent has been switched, the display control unit 17 causes the terminal apparatus 20 to display an identifiable indication of the switch of the dialogue partner.

The terminal apparatus 20 includes a reception unit 21, a communication unit 22, and a display control unit 23. Each of these functional units is implemented by processing executed by a CPU of the terminal apparatus 20 according to a program installed in the terminal apparatus 20.

The reception unit 21 receives an operation on the terminal apparatus 20 by the user.

The communication unit 22 controls communication with the information processing apparatus 10.

The display control unit 23 controls the display of screens, such as the interactive screen 510 described later, based on information received from the information processing apparatus 10, such as display content.

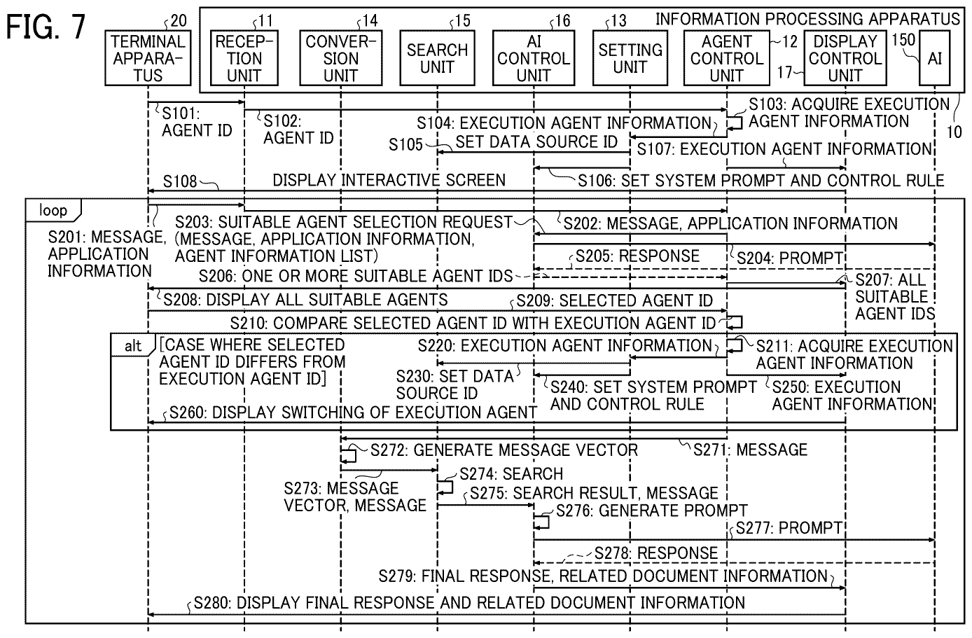

A procedure executed by the information processing system 1 is described below. FIG. 7 is a sequence diagram illustrating a procedure executed by the information processing system 1 according to the first embodiment. At the start of the procedure illustrated in FIG. 7, the user has logged in to the information processing apparatus 10 using the interactive area 500 of the application screen 300 displayed on the terminal apparatus 20 and has been authenticated by the information processing apparatus 10, and an execution agent selection screen is displayed in the interactive area 500. The execution agent selection screen displays a list of selectable agents. The list may include agents arranged in an order sorted based on the roles of the agents, such as in alphabetical order of character strings representing the roles. Some agents in the list may be designated as searchable. In this case, a keyword for search may be input on the execution agent selection screen, and some agents having a relatively high similarity in role to the keyword may be displayed on the execution agent selection screen.

When one of the agents displayed on the execution agent selection screen is selected by the user, in step S101, the terminal apparatus 20 transmits identification information of the selected agent to the information processing apparatus 10. This identification information may be referred to as an “agent ID” in the following description.

In response to the agent ID, in step S102, the reception unit 11 of the information processing apparatus 10 inputs the agent ID to the agent control unit 12.

In step S103, the agent control unit 12 acquires agent information corresponding to the input agent ID from the agent information storage unit 121.

The agent information acquired in step S103 in FIG. 7 may be referred to as “execution agent information” in the following description.

In step S104, the agent control unit 12 inputs the execution agent information to the setting unit 13.

In step S105, the setting unit 13 sets a data source ID of the input execution agent information in the search unit 15. In step S106, the setting unit 13 sets a control rule and a system prompt of the execution agent information in the AI control unit 16. As a result, the search unit 15 searches the data storage unit 122 corresponding to the execution agent, and the AI control unit 16 executes the control procedure corresponding to the execution agent.

In step S107, the agent control unit 12 provides the execution agent information to the display control unit 17. In step S108, the display control unit 17 causes an interactive screen in which the dialogue partner for the user is an agent (execution agent) related to the execution agent information to be displayed in the interactive area 500 of the application screen 300 displayed on the terminal apparatus 20. Specifically, the display control unit 17 generates display data for an interactive screen, and transmits the display data to the terminal apparatus 20 to display the interactive screen. The terminal apparatus 20 displays the interactive screen in the interactive area 500 based on the display data.

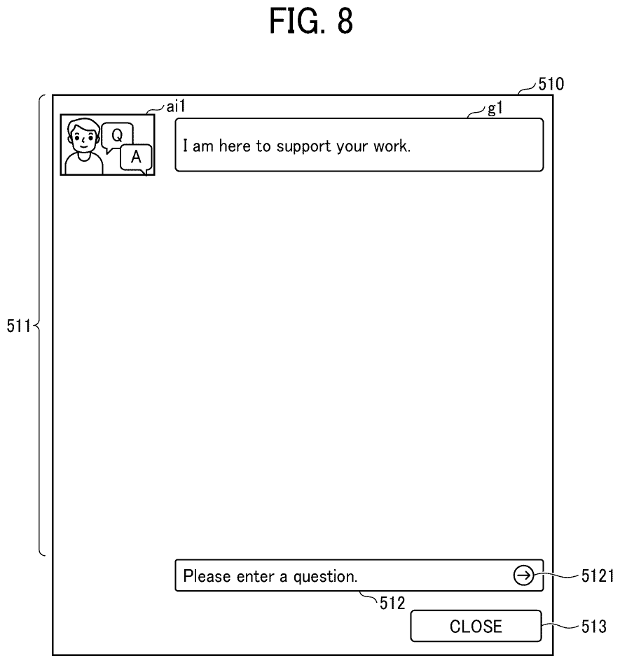

FIG. 8 is a diagram illustrating the interactive screen 510 displayed at the start of interaction. The interactive screen 510 illustrated in FIG. 8 includes an interactive display area 511, a message input area 512, and a button 513, and is displayed in the interactive area 500 of the application screen 300 (FIG. 2). The interactive display area 511 is an area in which the interaction content between the execution agent and the user is displayed. In the initial state, the interactive display area 511 displays a greeting message g1 “I am here to support your work.” prompting the user to input a message. An icon ai1 representing the execution agent is displayed to the left of the greeting message g1. The icon ai1 is an image stored in a file related to the icon name of the execution agent information. The icon ai1 allows the user to visually recognize the agent as the current dialogue partner, that is, the execution agent. The message input area 512 is an area for receiving input of a message from the user, and includes a send icon 5121. The button 513 is a button for receiving an instruction to end the interaction.

When the user inputs a message in the message input area 512 and clicks the send icon 5121, in step S201, the terminal apparatus 20 transmits the message (“target message”) to the information processing apparatus 10 together with the application information (“target application information”) of the application (“target application”) corresponding to the application screen 300 in which the interactive area 500 includes the interactive screen 510 where the message has been input.

In response to the target message and the target application information, in step S202, the reception unit 11 inputs the target message and the target application information to the agent control unit 12. In step S203, the agent control unit 12 inputs, to the AI control unit 16, an agent selection request including the target message, the target application information, and a list of all agent information items stored in the agent information storage unit 121. The selection request refers to a request for selecting one or more agents (“suitable agents”) that are more suitable than the execution agent for generating a response to the target message from the user currently using the target application. Being more suitable than an execution agent for generating a response refers to being able to output a response more appropriate than that of the execution agent.

In step S204, the AI control unit 16 generates a prompt for instructing the AI 150 to select one or more suitable agents based on the input target message, the target application information, the list of agent information, and a system prompt prepared in advance for selecting a suitable agent, and transmits the prompt to the AI 150. The prompt generated at this time is a prompt requesting the AI 150 to select, from among multiple agents having different roles, one or more agents having a role for generating a response more appropriate than that of the execution agent to the message from the user currently using the target application. In other words, the prompt is a prompt for causing the AI 150 to determine the type of response desired by the user currently using the target application, based on the message input by the user, and for causing the AI 150 to determine one or more agents that can provide a response of that type, based on the role of each agent.

The following is a simple example of a system prompt, which is a template of the prompt.

<Example of system prompt begins.>
The message from the user is as follows:
{Message}
The application this user uses to input the message is {application information}.
The followings are candidates for an agent that responds to the above message:
{List of agent IDs and agent descriptions}

Select, from among the agents listed above, all agents that can output a response more appropriate than that of the {execution agent} to the above message in consideration of the application used by the user, and output the agent IDs of those agents.

### <Example of System Prompt Ends.>

In this case, the AI control unit 16 generates a prompt by inserting the target application information to the {application information} section of the system prompt, inserting the target message to the {message} section, inserting the agent ID and description of the agent (that is, the role of the agent) to the {list of agent IDs and agent descriptions} section for each agent, and inserting the agent ID of the execution agent to the {execution agent} section. Although the above system prompt instructs the selection of “all” agents that can output a response more appropriate than that of the execution agent, the system prompt may instruct the selection of the “top X agents” instead of “all” agents.

The AI 150 that has received the prompt generated as described above selects one or more suitable agents from among the agents listed in the prompt based on the trained parameters, and generates a response including the ID of the selected agent. The AI 150 transmits the response to the AI control unit 16.

In step S205, the AI control unit 16 receives the response from the AI 150. The response is the agent ID(s) of one or more agents selected as the suitable agents.

In step S206, the AI control unit 16 outputs the agent ID of each of the one or more agents to the agent control unit 12. This agent ID may be referred to as a “suitable agent ID” in the following description.

In step S207, the agent control unit 12 inputs all the suitable agent IDs output by the AI control unit 16 to the display control unit 17. In step S208, the display control unit 17 generates display data of the interactive screen 510 including display information for selecting a new execution agent (an agent that generates a response to the target message) from among one or more suitable agents, and transmits the display data to display the generated screen in the interactive area 500 of the application screen 300 (FIG. 2) displayed on the terminal apparatus 20.

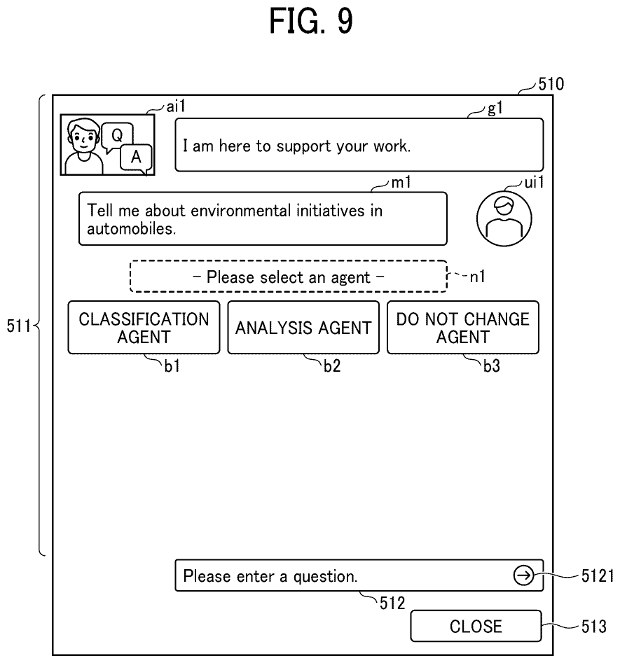

FIG. 9 is a diagram illustrating an interactive screen that includes display information for selecting a new execution agent. In FIG. 9, identical or similar reference signs are given to elements similar to those illustrated in FIG. 8, and redundant descriptions thereof are omitted unless otherwise required. In the interactive screen 510 illustrated in FIG. 9, a message m1, an icon ui1, a notice n1, and buttons b1 to b3 are added. The interactive screen 510 illustrated in FIG. 9 is also displayed in the interactive area 500 of the application screen 300 (FIG. 2).

The message m1 is the target message input by the user in the message input area 512 in step S201. When the user clicks the send icon 5121, the target message input in the message input area 512 is displayed in the interactive display area 511. The icon ui1 is an icon of the user.

The notice n1 and the buttons b1 to b3 are examples of display information for selecting a new execution agent from one or more suitable agents.

The notice n1 is a notice for prompting the user to select an agent. The buttons b1 and b2, corresponding individually to suitable agents, are buttons for selecting the corresponding suitable agent as a new execution agent. In FIG. 9, two buttons (buttons b1 and b2) are displayed corresponding to two kinds of suitable agents. The button b3 is a button for selecting not to change the execution agent.

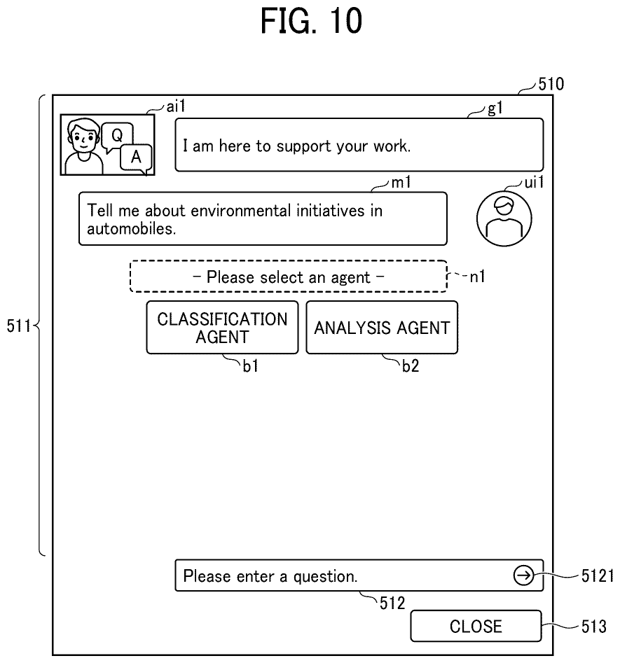

FIG. 10 is a diagram illustrating an interactive screen that includes display information for selecting a new execution agent according to a modification. In FIG. 10, identical or similar reference signs are given to elements similar to those illustrated in FIG. 9, and redundant descriptions thereof are omitted unless otherwise required. The interactive screen 510 illustrated in FIG. 10 is also displayed in the interactive area 500 of the application screen 300 (FIG. 2). The interactive screen 510 illustrated in FIG. 10 does not include the button b3. In this way, The option to keep the current execution agent may be made unselectable.

When the user selects one of the buttons b1 to b3, in step S209, the terminal apparatus 20 transmits to the information processing apparatus 10 the agent ID of the agent corresponding to the selected button. This agent ID may be referred to as a “selected agent ID” in the following description. When the button b1 or b2 is selected, the agent ID of the suitable agent corresponding to the selected button is the selected agent ID. When the button b3 is selected, the agent ID of the current execution agent is the selected agent ID.

When the button b1 or b2 is selected in FIG. 10, the terminal apparatus 20 may ask the user whether to switch the execution agent, before transmitting the selected agent ID.

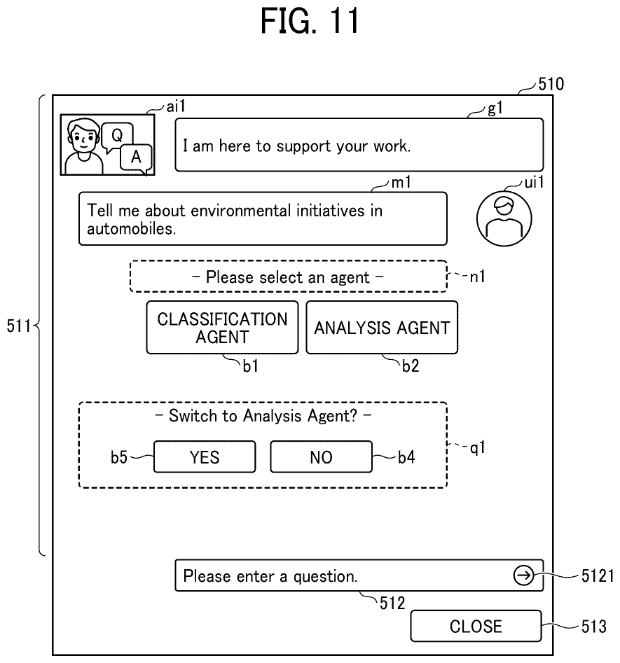

FIG. 11 is a diagram illustrating an interactive screen 510 allowing a user to select whether to switch an execution agent. In FIG. 11, identical or similar reference signs are given to elements similar to those illustrated in FIG. 10, and redundant descriptions thereof are omitted unless otherwise required. The interactive screen 510 illustrated in FIG. 11 is also displayed in the interactive area 500 of the application screen 300 (FIG. 2). The interactive screen 510 of FIG. 11 corresponds to a case where the button b2 is selected, and includes an area q1 that includes a character string indicating whether to switch to the analysis agent, together with buttons b4 and b5. The button b5 is a button for receiving selection of switching. The button b4 is a button for receiving selection of non-switching. In this case, when the button b5 is selected, the terminal apparatus 20 transmits the selected agent ID to the information processing apparatus 10, and when the button b4 is selected, the terminal apparatus 20 transmits the agent ID of the current execution agent to the information processing apparatus 10.

In response to the selected agent ID, in step S210, the agent control unit 12 compares the selected agent ID with the agent ID of the execution agent information acquired in step S103 to determine whether an agent that can output a response more appropriate than that of the execution agent to the target message is present. The agent ID of the execution agent information may be referred to as an “execution agent ID” in the following description.

When the selected agent ID and the execution agent ID differ from each other, the agent control unit 12 determines that an agent that can output a response more appropriate than that of the execution agent to the target message is present. In this case, steps S211 to S260 are executed, and the execution agent is changed. When the selected agent ID and the execution agent ID are the same, the agent control unit 12 determines that an agent that can output a response more appropriate than that of the execution agent to the target message is not present. In this case, steps S211 to S260 are skipped, and the subsequent steps starting from step S271 are executed.

First, a description is given below of the case where the selected agent ID and the execution agent ID are the same, that is, the case where the button b3 in FIG. 9 is selected. In step S271, the agent control unit 12 inputs the target message to the conversion unit 14.

In step S272, the conversion unit 14 converts the input target message into a semantic vector to generate a message vector. In step S273, the conversion unit 14 inputs the message vector and the target message to the search unit 15. This message vector may be referred to as a “target message vector” in the following description.

In step S274, the search unit 15 compares the input target message vector with the chunk vector stored for each document data and for each chunk in the data storage unit 122 related to the data source ID set by the setting unit 13 (that is, the data storage unit 122 corresponding to the execution agent) to identify a similar chunk for each document data and extract one or more similar chunks having a relatively high similarity to the target message. For example, the search unit 15 extracts the top X similar chunks in terms of similarity between the target message vector and the chunk vector. The search unit 15 generates, for each of the extracted similar chunks, a search result including related document information of the similar chunk. In step S275, the search unit 15 inputs the search result and the target message to the AI control unit 16.

In step S276, the AI control unit 16 generates a prompt based on the input search result and target message, and the control rule and system prompt set by the setting unit 13. In step S277, the AI control unit 16 transmits the prompt to the AI 150.

In step S278, the AI control unit 16 receives, from the AI 150, a response generated by the AI 150 that has received the prompt. Depending on the control procedure, the first response may not be the final response. In this case, the final response is acquired by repeating steps S276 to S278 multiple times.

When acquiring the final response, the AI control unit 16 records the final response in the history information storage unit 123 in association with the target message and the search result.

In step S279, the AI control unit 16 inputs to the display control unit 17 final response information including the final response and the related document information included in the search result. This final response may be referred to as a “target final response” in the following description.

In step S280, the display control unit 17 causes the input final response information, including the target final response and the related document information, to be displayed on the interactive screen 510, which is displayed on the terminal apparatus 20. Specifically, the display control unit 17 generates display data of the final response information and transmits the generated display data to the terminal apparatus 20 to cause the final response information to be displayed on the interactive screen 510, which is displayed on the terminal apparatus 20.

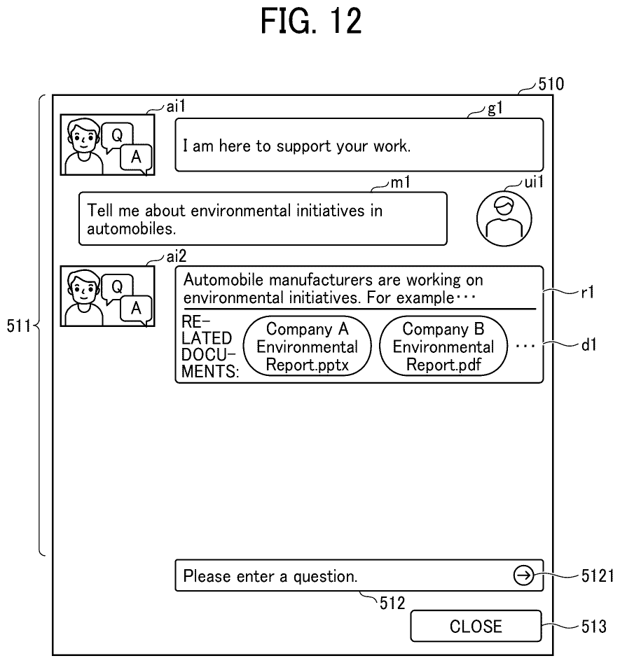

FIG. 12 is a diagram illustrating final response information. In FIG. 12, identical or similar reference signs are given to elements similar to those illustrated in FIG. 9, and redundant descriptions thereof are omitted unless otherwise required. The interactive screen 510 illustrated in FIG. 12 is also displayed in the interactive area 500 of the application screen 300 (FIG. 2). In the interactive screen 510 illustrated in FIG. 12, a response r1 and related document information d1 are added.

The response r1 is a target final response. The related document information d1 is related document information for the target final response. Thus, information including the response r1 and the related document information d1 is final response information for the message m1. FIG. 12 illustrates an example in which a list of document names included in the related document information is displayed as the related document information d1. The target final response may be output in multiple speech bubbles.

An icon ai2 is also added to the left side of the response r1 in FIG. 12. The icon ai2 is an icon of the execution agent that has provided the final response. Since the execution agent is not switched, the icon ai2 is the same as the icon ai1.

Although FIG. 12 illustrates an example in which the notice n1 and the buttons b1 to b3 displayed in FIG. 9 are deleted, the notice n1 and the buttons b1 to b3 may be displayed on the interactive screen 510 in FIG. 12.

The user may continue the interaction or may end the interaction. To end the interaction, the user clicks the button 513. In this case, the session ends, and the procedure illustrated in FIG. 7 ends. To continue the interaction, the user inputs a new message in the message input area 512 and clicks the send icon 5121. In this case, the steps starting from step S201 are repeated using the message as the target message. In other words, the steps starting from step S201 are repeatedly executed until the button 513 is clicked.

A description is given below of the case where the selected agent ID and the execution agent ID differ from each other in the process of executing the steps starting from step S201. In this case, steps S211 to S260 are executed.

In step S211, the agent control unit 12 acquires agent information corresponding to the selected agent ID from the agent information storage unit 121 (FIG. 5) as execution agent information. In steps S220 to S250, processing similar to that in steps S104 to S107 is executed. When the new execution agent information is provided in step S250, in step S260, the display control unit 17 causes information enabling identification of the switch of the execution agent to be displayed on the currently displayed interactive screen 510.

Specifically, the display control unit 17 generates display data for displaying information enabling identification of the switch of the execution agent, and transmits the display data to the terminal apparatus 20.

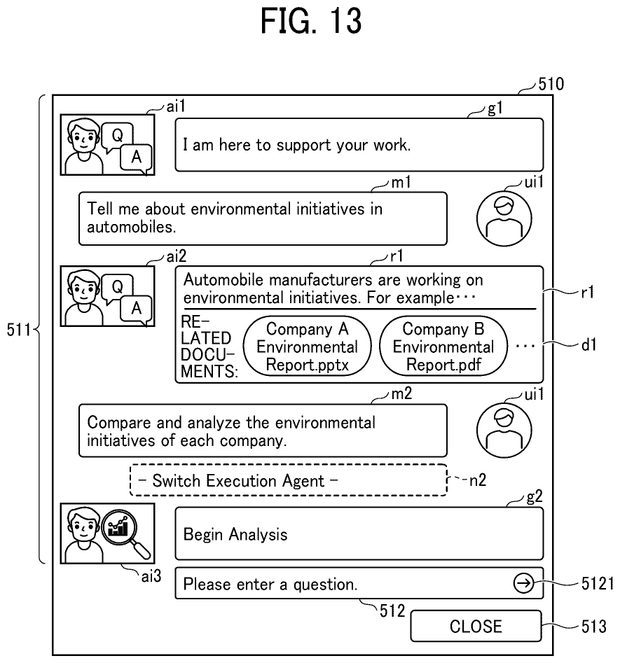

FIG. 13 is a diagram illustrating the interactive screen 510 indicating the switch of an execution agent. In FIG. 13, identical or similar reference signs are given to elements similar to those illustrated in FIG. 12, and redundant descriptions thereof are omitted unless otherwise required. The interactive screen 510 illustrated in FIG. 13 is also displayed in the interactive area 500 of the application screen 300 (FIG. 2). In the interactive screen 510 illustrated in FIG. 13, a message m2, a notice n2, a greeting message g2, and an icon ai3 are added. The message m2 is a new target message. FIG. 13 illustrates an example of display when the suitable agent for the message m2 is not the execution agent. Before the notice n2 and the greeting message g2 are displayed, the display information corresponding to the notice n1 and the buttons b1 to b3 illustrated in FIG. 9 is displayed below the message m2 in step S208. When the button corresponding to the suitable agent is selected, the interactive screen 510 illustrated in FIG. 13 is displayed.

The notice n2 and the greeting message g2 are display information added in step S260 to notify the user of the switch of the execution agent. The notice n2 is a character string indicating the switch of the execution agent. The greeting message g2 is a greeting message from the new execution agent.

The icon ai3 located to the left of the greeting message g2 differs from the previously displayed icons ai1 and ai2 of the execution agents. This is because the icon ai3 is related to the icon name included in the agent information of the new execution agent. Thus, the switch of the icon also enables the user to identify the switch of the execution agent.

After step S260 in FIG. 7, the steps starting from step S271 are executed. In this case, in step S274, the search unit 15 searches for document data from the data storage unit 122 corresponding to the data source ID set in step S230. The AI control unit 16 executes steps S276 to S278 based on the control rule and system prompt set in step S240 to acquire the final response. As a result, a response that is based on document data different from that of the execution agent before the switching and that is based on a system prompt (inquiry method) different from that of the execution agent before the switching can be acquired as the final response. In other words, the final response corresponding to the execution agent after the switching is acquired. Thus, the possibility of outputting a more appropriate response to the message from the user increases.

As described above, according to the first embodiment, the agent control unit 12 determines whether one or more agents (second agents) that can output a response more appropriate than that of the execution agent (first agent) to the message from the user and the application information of the application used (operated) by the user are present among multiple types of agents having different roles. When one or more such agents are present, one or more second agents are displayed as selectable, and the execution agent is switched to a selected second agent. Thus, the execution agent can be switched to the agent that can output a more appropriate response to the message received from the user. As a result, the quality of the response to the message from the user can be increased. In particular, by determining the suitable agent based on the application information together with the message, the agent control unit 12 can determine a suitable agent in consideration of the situation of the user (what kind of operation the user is doing) for the same message. For example, when the user uses a spreadsheet application, the possibility that an agent that analyzes data is selected as a suitable agent can be increased.

Although the notice n1, the greeting message g2, the icon ai3, and similar elements in FIG. 13 are displayed in step S260 (FIG. 7) as examples of information enabling identification of the switch of the execution agent, the information may be implemented in other forms. For example, in step S260, the display control unit 17 may display the agent name of the execution agent in addition to the icon ai3 or instead of the icon ai3.

Alternatively, in step S260, the display control unit 17 may cause a new interactive screen 510 for interacting with the execution agent after the switching to be displayed on the terminal apparatus 20, independently of the currently displayed interactive screen 510. The display may be performed in other forms provided that the user can identify the switch of the execution agent.

Although an example in which the suitable agent is identified by the procedure illustrated in steps S202 to S206 (FIG. 7) has been described, the suitable agent may be identified by other procedures.

For example, after the agent control unit 12 determines whether the execution agent is suitable and when the execution agent is not suitable, the suitable agent may be identified. This case is described below as a second embodiment.

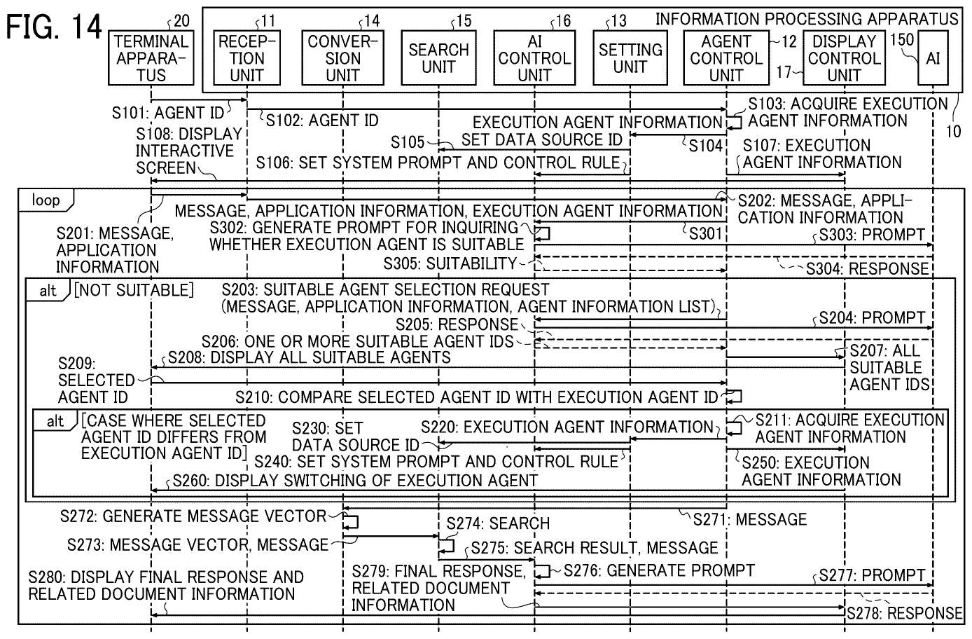

FIG. 14 is a sequence diagram illustrating a procedure executed by the information processing system 1 according to the second embodiment. In FIG. 14, identical or similar step numbers denote identical or similar steps illustrated in FIG. 7, and redundant descriptions thereof are omitted unless otherwise required.

Following step S202, in step S301, the agent control unit 12 inputs the target message, the target application information, and the agent information of the current execution agent (execution agent information) to the AI control unit 16. In step S302, the AI control unit 16 generates a prompt for inquiring whether the execution agent is suitable, based on the target message, the target application information, and the description of the execution agent information. For example, the AI control unit 16 may generate a prompt with content such as: “Is the execution agent, which plays the role as indicated by the description, suitable for responding to the target message from the user currently using the application related to the target application information?” In step S303, the AI control unit 16 transmits the prompt to the AI 150. In step S304, the AI control unit 16 receives a response, indicating whether the execution agent is suitable, from the AI 150. In step S305, the AI control unit 16 outputs the response, in other words, the suitability of the execution agent, to the agent control unit 12. When the response indicates that the execution agent is suitable, steps S203 to S260 are skipped, and the subsequent steps starting from step S271 are executed. When the response indicates that the execution agent is not suitable, the steps starting from step S203 are executed. In this case, in step S210, the agent control unit 12 determines whether an agent different from the execution agent is selected.

Thus, by preparing the control rule for each agent in advance, the dialogue partner can be switched to another agent that provides an appropriate response to a message input by the user, based on the description that explains the role of the agent, which is implemented by the agent being controlled according to the control rule, and the capabilities of the agent, together with the message input by the user. In addition, by determining whether to switch agents each time a message is received, even during an ongoing interaction with the interactive AI, the information processing apparatus 10 can present another suitable interactive AI to respond to the message and switch from the current interactive AI when such a suitable operator is present. Accordingly, the user can switch to a different interactive AI during the interaction on the interactive screen without transitioning to another screen such as a screen for selecting an interactive AI.

Although an example in which the user is allowed to select an execution agent has been described, the agent control unit 12 may automatically select an execution agent. In this case, the prompt generated and transmitted in step S204 in FIG. 7 or 14 may be any prompt requesting the AI 150 to select, from among multiple agents having different roles, one or more agents having a role for generating the most appropriate response to the message from the user currently using the target application.

The following is a simple example of a system prompt, which is a template of the prompt.

<Example of system prompt begins.>
The message from the user is as follows:
{Message}
The application this user uses to input the message is {application information}.
The followings are candidates for an agent that responds to the above message:
{List of agent IDs and agent descriptions}

Select, from among the agents listed above, an agent that can output the most appropriate response to the above message in consideration of the application used by the user, and output the agent ID of the agent.

### <Example of System Prompt Ends.>

In this case, steps S208 and S209 are skipped. When the agent ID output from the AI 150 differs from the agent ID of the execution agent, steps S211 to S260 are executed. Thus, when the message m1 illustrated in FIG. 9 is the target message and the execution agent is switched, the user is not given an opportunity to select an execution agent (as the buttons b1 to b3 are not displayed), and the final response is displayed in the step S280.

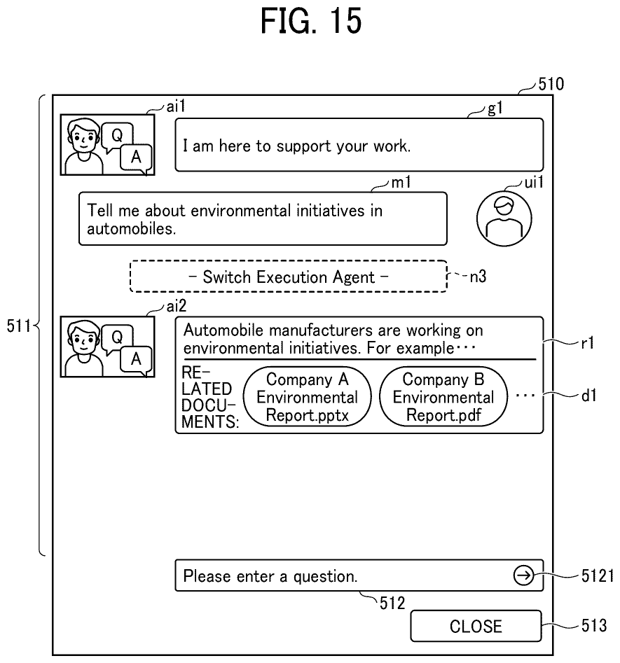

FIG. 15 is a diagram illustrating an interactive screen for switching an execution agent without allowing user selection. In FIG. 15, identical or similar reference signs are given to elements similar to those illustrated in FIG. 12, and redundant descriptions thereof are omitted unless otherwise required. The interactive screen 510 illustrated in FIG. 15 is also displayed in the interactive area 500 of the application screen 300 (FIG. 2). In FIG. 15, a notice n3 is display information added in step S260 to notify the user of the automatic switching of the execution agent.

When the execution agent is automatically switched, the user may be allowed to select whether to switch the execution agent, as in FIG. 11.

Although an example in which the interaction between the user and the agent is performed in the interactive area 500 has been described, the screen configuration for the interaction on the application screen 300 is not limited thereto.

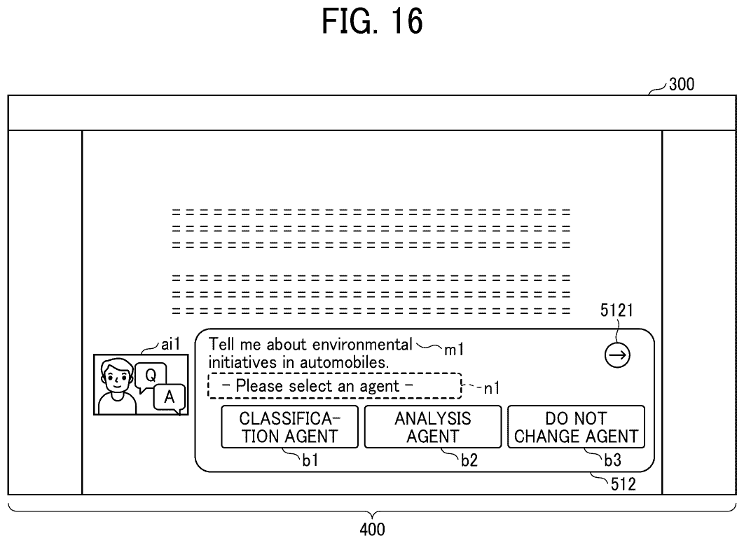

FIG. 16 is a diagram illustrating a screen configuration for interaction on the application screen 300 according to a modification. In FIG. 16, identical or similar reference signs are given to elements similar to those illustrated in FIG. 2 or 9, and redundant descriptions thereof are omitted unless otherwise required.

The application screen 300 illustrated in FIG. 16 does not include the interactive area 500, and includes the message input area 512 below the content area 400. The icon of the agent serving as the current dialogue partner is located to the left of the message input area 512. In FIG. 16, the icon ai1 is located to the left of the message input area 512. In the message input area 512, a message input by the user and a response from the agent are displayed. The state of the message input area 512 in FIG. 16 corresponds to the state of the interactive screen 510 in FIG. 9. Specifically, FIG. 16 illustrates the message input area 512 where the notice n1 and the buttons b1 to b3 are displayed after the user inputs the message m1 and clicks the send icon 5121. The response from the agent may be displayed in the content area 400 instead of the message input area 512.

Thus, the screen configuration for interaction on the application screen 300 is not limited to a specific configuration. The interaction between the user and the agent may be performed on the application screen 300 by a configuration other than the screen configuration exemplified in the present embodiment. According to such an embodiment, for example, when a message is input during an interaction between a user and an execution agent (first agent) on a screen of a document generation application, the execution agent is switched to a configuration creation agent (second agent) that can respond more appropriately than the first agent and is related to or having a high affinity for the document generation application. Specifically, for example, the execution agent is switched to the configuration creation agent (second agent) according to a determination made by a determination unit based on history information indicating that the user who uses the document generation application interacts with the configuration creation agent with high frequency or based on a feature that the final output from the configuration creation agent is similar to content input to the document generation application. When the same message is input on the screen of the spreadsheet application during an interaction between the user and the execution agent (first agent), the execution agent is switched to an analysis agent (third agent) that can respond more appropriately than the first agent and is related to or having a high affinity for the document generation application. Specifically, for example, the execution agent is switched to the analysis agent (third agent) by the determination unit determining, based on history information indicating that the user who uses the spreadsheet application interacts with the analysis agent with high frequency or based on a feature that an output finally output by the analysis agent is similar to content input to the spreadsheet application. As described above, when the same message is input as a message to the execution agent while the application information of the application used by the user is different, the execution agent can be switched to a different agent because the determination is made based on the application information.

In the above embodiments, the message and the application information are transmitted to the agent, and the agent is instructed to select an agent in consideration of the application used by the user, thereby determining whether an agent that can output an appropriate response to the message from the user using the application. However, the present disclosure is not limited thereto. For example, correspondence information associating a specific agent with each application may be prepared in advance and the message, the application information, and the correspondence information may be transmitted to the agent so that the AI can select an agent that can appropriately respond to the message from among agents associated with an application identified by the application information.

A third embodiment is described below. In the third embodiment, the differences from the first embodiment (or aspects not explicitly described) are described. Accordingly, aspects not specifically mentioned may be similar to those in the first embodiment.

In the third embodiment, an example is described in which the terminal apparatus 20 displays various screens by a web browser while the information processing apparatus 10 has a function as a web server that executes a web application.

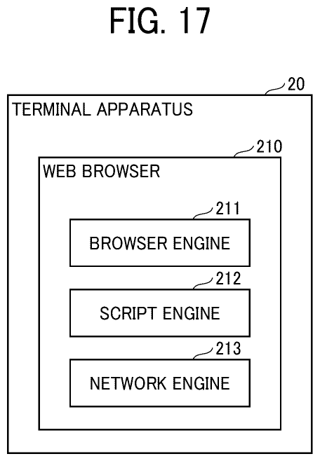

FIG. 17 is a block diagram illustrating a functional configuration of the terminal apparatus 20 according to the third embodiment. In FIG. 17, the terminal apparatus 20 includes a web browser 210. The web browser 210 is a typical web browser, and includes a browser engine 211, a script engine 212, and a network engine 213.

The browser engine 211 interprets HyperText Markup Language (HTML) data and Cascading Style Sheets (CSS) data forming a web page and renders the web page for display. The script engine 212 executes a script (for example, JavaScript®) forming a web page.

The network engine 213 transmits a HyperText Transfer Protocol (HTTP) request and receives an HTTP response.

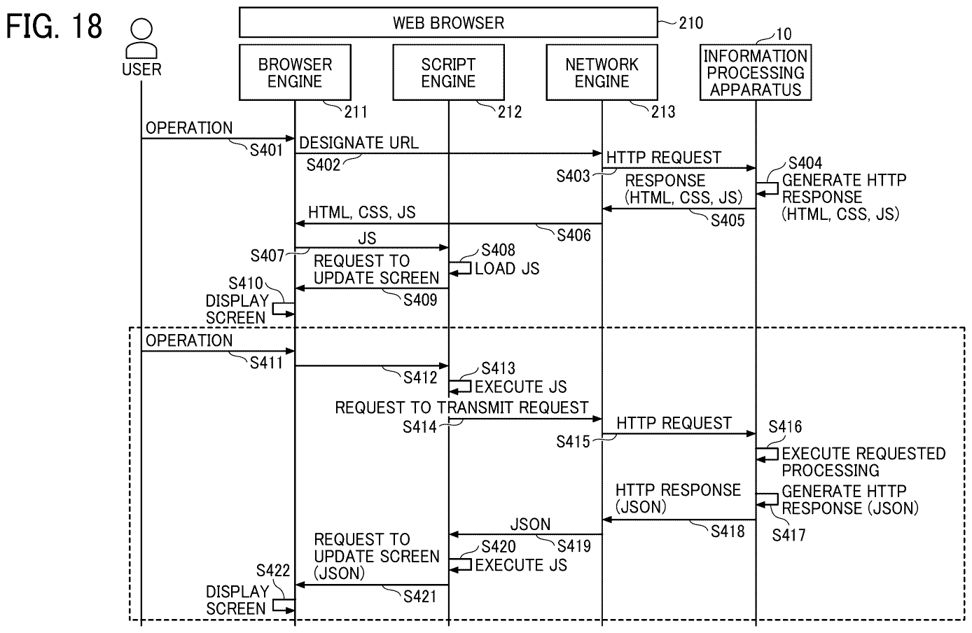

FIG. 18 is a sequence diagram illustrating a procedure related to screen transition according to the third embodiment. At the start of the procedure illustrated in FIG. 18, an execution agent selection screen is displayed on the web browser 210 included in the interactive area 500 of the application screen 300 displayed on the terminal apparatus 20.

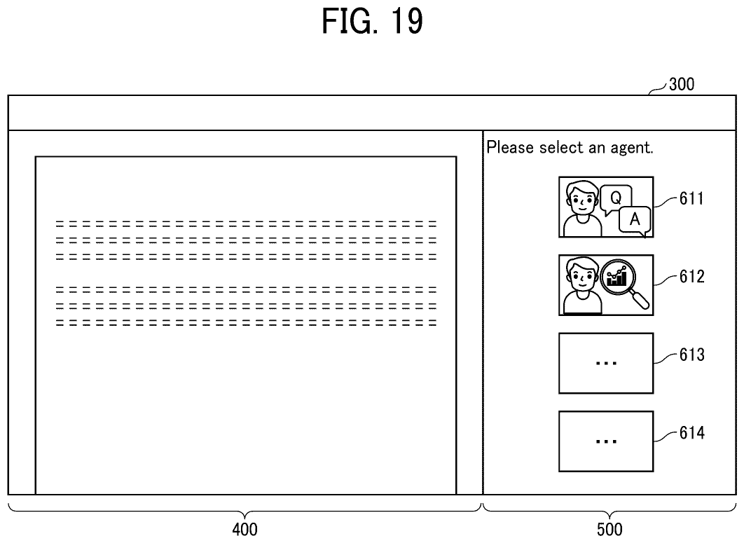

FIG. 19 is a diagram illustrating an execution agent selection screen. As illustrated in FIG. 19, on the execution agent selection screen, icons 611 to 614, which represent respective selectable agents, are displayed.

In step S401, the browser engine 211 receives a user operation including selection of any one of the icons on the execution agent selection screen. In step S402, the browser engine 211 inputs, to the network engine 213, a URL that includes, as option information, the agent ID of the agent corresponding to the selected icon or information for identifying the selected icon and that serves as a destination for an HTTP request to the information processing apparatus 10. In step S403, the network engine 213 transmits the HTTP request to the URL.

In response to the HTTP request, in step S404, the display control unit 17 of the information processing apparatus 10 generates an HTTP response including web content data corresponding to the URL to which the HTTP request is addressed. The web content data includes HTML data, CSS data, and a script. The script may be referred to as a “JS” in the following description. The web content is used to display multiple web pages to be displayed later. The JS includes multiple JS scripts that execute processing in response to one or more operations performed on each screen.

In step S405, the display control unit 17 transmits the HTTP response generated in step S404 to the terminal apparatus 20.

In response to the HTTP response, in step S406, the network engine 213 of the terminal apparatus 20 inputs the HTML data, the CSS data, and the JS included in the HTTP response to the browser engine 211. In step S407, the browser engine 211 inputs the JS received from the network engine 213 to the script engine 212. In step S408, the script engine 212 loads the JS. In step S409, the script engine 212 requests the browser engine 211 to update the screen. Updating the screen includes displaying a new screen.

The HTTP response generated in step S404 may include the filename of the JS instead of the actual JS. In this case, in step S408, the script engine 212 accesses an external file based on the filename, and downloads the JS. This is a way of reading a JS as an external file.

In step S410, the browser engine 211 displays the interactive screen 510 in the interactive area 500 of the application screen 300 (FIG. 8) based on the HTML data and the CSS data. For example, when the icon 611 is selected on the execution agent selection screen, the interactive screen 510 illustrated in FIG. 8 is displayed in the interactive area 500 of the application screen 300 (FIG. 8).

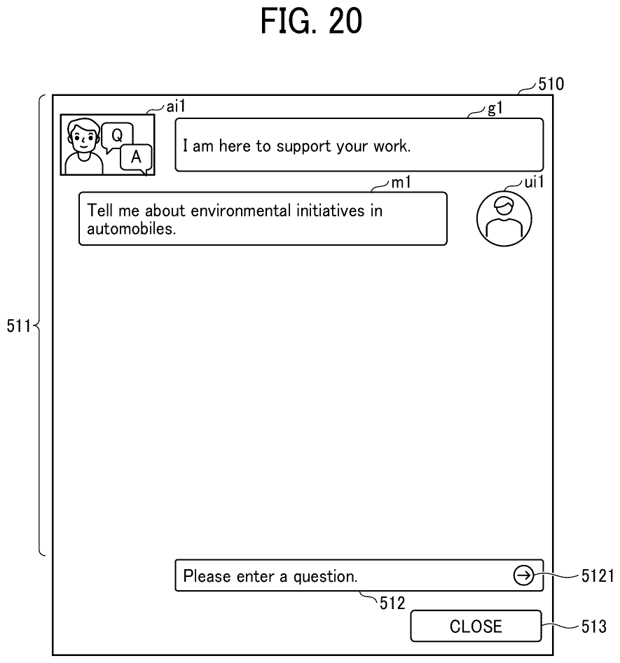

In step S411, the browser engine 211 receives a user operation including input of a message to the message input area 512 of the interactive screen 510 (FIG. 8) and clicking of the send icon 5121. In response to the user operation, the display content of the interactive screen 510 changes as illustrated in FIG. 20. In FIG. 20, the message (“target message”) input in the message input area 512 illustrated in FIG. 8 is displayed as the message m1 in the interactive display area 511, and the icon ui1 indicating the user is added. In step S412, the browser engine 211 notifies the script engine 212 that the target message has been input, together with the target message.

In response to the notification from the browser engine 211, in step S413, the script engine 212 executes a JS of multiple JS scripts, the JS being for transmitting the target message and application information of the target application to the information processing apparatus 10. In step S414, the script engine 212 inputs, to the network engine 213, a request to transmit an HTTP request in response to the input of the target message, the HTTP request including the target message and the application information. In step S415, the network engine 213 transmits the HTTP request including the target message and the application information to the information processing apparatus 10.

When the reception unit 11 of the information processing apparatus 10 receives the HTTP request, in step S416, the information processing apparatus 10 executes processing requested by the HTTP request. Steps S202 to S207 illustrated in FIG. 7 are executed for the HTTP request in response to the input of the message on the interactive screen 510 illustrated in FIG. 8. Accordingly, one or more suitable agent IDs for the target message and the target application are acquired as a processing result.

In step S417, the display control unit 17 generates an HTTP response including JavaScript® Object Notation (JSON) in which all the suitable agent IDs that are the processing result are described. In step S418, the display control unit 17 transmits the HTTP response to the terminal apparatus 20.

In response to the HTTP response, in step S419, the network engine 213 of the terminal apparatus 20 inputs the JSON included in the HTTP response to the script engine 212. In step S420, the script engine 212 executes a JS of multiple JS scripts, the JS being for updating the display content of the web page based on the JSON. In step S421, the script engine 212 requests the browser engine 211 to update the display content of the web page based on the JSON. In step S422, the browser engine 211 updates the display content of the interactive screen 510 from the state illustrated in FIG. 20 to the state illustrated in FIG. 9, based on the HTML data and CSS data acquired in step S406 and the JSON.

Thereafter, steps S411 to S422 are repeated in response to a user operation on the interactive screen 510. However, the data to be processed in each step changes.

For example, when the browser engine 211 receives a user operation including selection of any one of the buttons b1 to b3 on the interactive screen 510 (FIG. 9) in step S411, in step S412, the browser engine 211 notifies the script engine 212 that the one of the buttons b1 to b3 has been selected.

In response to the notification from the browser engine 211, in step S413, the script engine 212 executes a JS of multiple JS scripts, the JS being for transmitting the agent ID corresponding to the selected button, that is, the selected agent ID, to the information processing apparatus 10. In step S414, the script engine 212 inputs, to the network engine 213, a request to transmit an HTTP request in response to the selection of the one of the buttons b1 to b3, the HTTP request including the selected agent ID. In step S415, the network engine 213 transmits the HTTP request including the selected agent ID to the information processing apparatus 10.

When the reception unit 11 of the information processing apparatus 10 receives the HTTP request, in step S416, the information processing apparatus 10 executes processing requested by the HTTP request. The steps starting from step S210 in FIG. 7 are executed for the HTTP request in response to the selection of the one of the buttons b1 to b3 on the interactive screen 510 illustrated in FIG. 9. A description is given below of a case where steps S211 to S260 are executed following step S210.

In this case, in step S417, the display control unit 17 generates an HTTP response including JSON in which information enabling identification of the switch of the execution agent is described. In step S418, the display control unit 17 transmits the HTTP response to the terminal apparatus 20. The HTTP response corresponds to step S260 illustrated in FIG. 7.

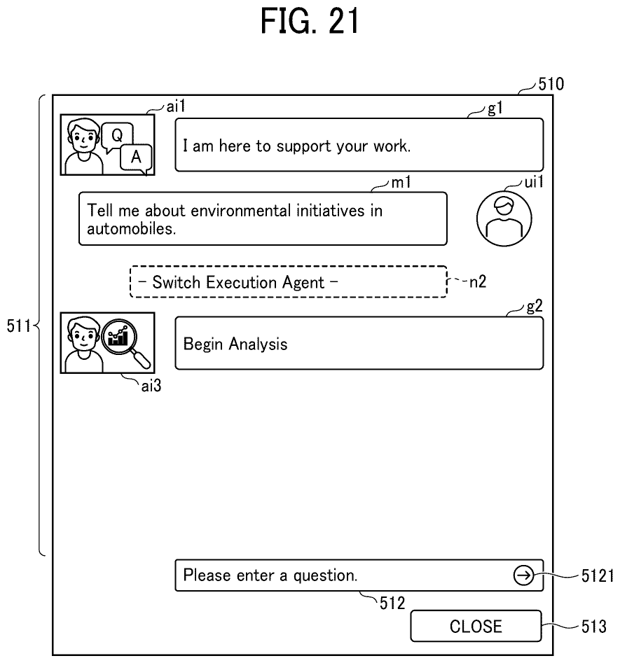

In response to the HTTP response, in step S419, the network engine 213 of the terminal apparatus 20 inputs the JSON included in the HTTP response to the script engine 212. In step S420, the script engine 212 executes a JS of multiple JS scripts, the JS being for updating the display content of the web page based on the JSON. In step S421, the script engine 212 requests the browser engine 211 to update the display content of the web page based on the JSON. In step S422, the browser engine 211 updates the display content of the interactive screen 510 from the state illustrated in FIG. 9 to the state illustrated in FIG. 21, based on the HTML data and CSS data acquired in step S406 and the JSON. In the interactive screen 510 illustrated in FIG. 21, the notice n1 and the buttons b1 to b3 displayed in FIG. 9 are deleted, and the notice n2, the greeting message g2, and the icon ai3 illustrated in FIG. 13 are added. In other words, one or more of the notice n2, the greeting message g2, and the icon ai3 are examples of information enabling identification of the switch of the execution agent, and the interactive screen 510 including the identification information is an example of a screen indicating the switch of the execution agent.

In the third embodiment, the agent control unit 12 may automatically select an execution agent. In this case, in step S416 among steps S412 to S422 in FIG. 18 executed in response to the input of the message as in the interactive screen 510 in FIG. 20, steps S202 to S207, S210, and S211 to S260 in FIG. 7 are executed. In this case, in step S417, the display control unit 17 generates an HTTP response including JSON in which information enabling identification of the switch of the execution agent is described. As a result, when viewed from the user, the display content of the interactive area 500 of the application screen 300 transitions from the interactive screen 510 illustrated in FIG. 9 to the interactive screen 510 illustrated in FIG. 21.

The third embodiment is also applicable to a case where the application screen 300 has the layout of the modification illustrated in FIG. 16.

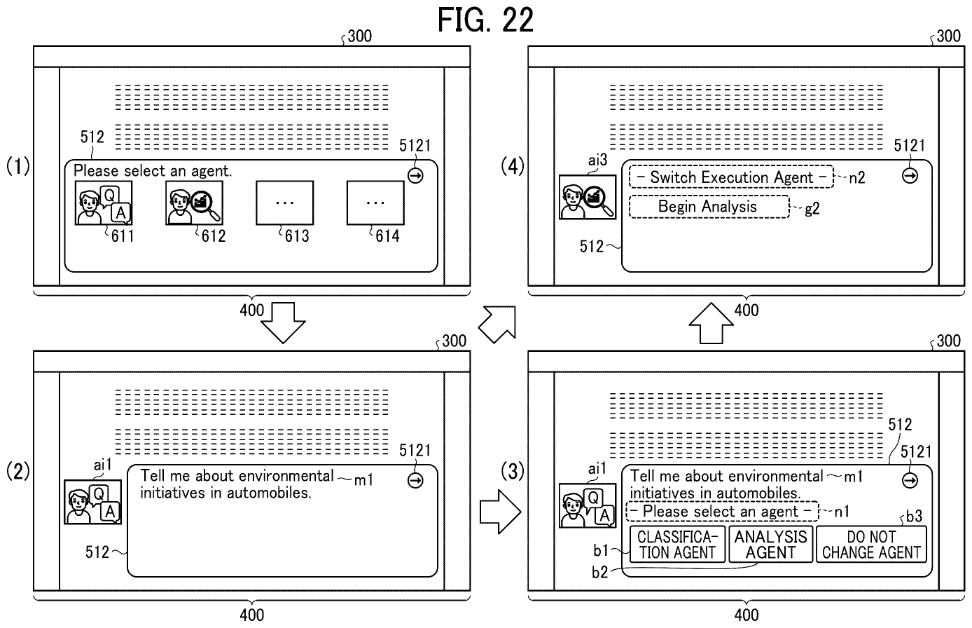

FIG. 22 is a diagram illustrating a screen transition of the application screen 300 according to a modification of the third embodiment. The message input area 512 illustrated in FIG. 22 (1) corresponds to the execution agent selection screen illustrated in FIG. 19. The icon ai1 and the message input area 512 illustrated in FIG. 22 (2), to which FIG. 22 (1) has transitioned, correspond to the interactive screen 510 illustrated in FIG. 20. The icon ai1 and the message input area 512 illustrated in FIG. 22 (3), to which FIG. 22 (2) has transitioned, correspond to the interactive screen 510 illustrated in FIG. 9. The icon ai3 and the message input area 512 illustrated in FIG. 22 (4), to which FIG. 22 (3) has transitioned, correspond to the interactive screen 510 illustrated in FIG. 21. As described above, FIG. 22 (2) may transition to FIG. 22 (4).

As described above, in the third embodiment, web content data is transmitted to the terminal apparatus 20. The web content data is used to display a first web page (e.g., FIG. 8) and a second web page (e.g., FIG. 21). The first web page presents a screen for receiving input of a message from a user and displays information for identifying a first interactive AI. The second web page displays an identifiable indication of the switch of the dialogue partner to a second interactive AI. The web content data includes a script for causing the terminal apparatus 20 to execute at least a process for transmitting the message input on the first web page to the information processing apparatus 10, and a process for displaying the second web page that presents a screen indicating the switch of the dialogue partner to the second interactive AI.

When the reception unit 11 receives an HTTP request that is transmitted from the terminal apparatus 20 executing the script and that includes the message input on the first web page displayed on the terminal apparatus 20 based on the web content data, the agent control unit 12 serving as the determination unit determines whether the second interactive AI that can output a response more appropriate than that of the first interactive AI to the message is present among multiple types of interactive AIs based on the message and application information.

When the agent control unit 12 determines that the second interactive AI is present, the display control unit 17 transmits to the terminal apparatus 20 an HTTP response including information for displaying an identifiable indication of the switch of the dialogue partner, as a response to the HTTP request.

In this way, the web content data including JS scripts is transmitted to the terminal apparatus 20 at one time in step S405. The JS scripts include scripts for executing processing in response to one or more operations performed on the first web page and processing in response to one or more operations performed on each web page displayed after screen transition, such as the second web page displayed after screen transition resulted from the processing in response to the one or more operations performed on the first web page. Since each screen transition is executed by the JS, the terminal apparatus 20 does not need to download the web content data after the screen transition again. Accordingly, the display speed of screens such as the second screen is increased and the communication load in the screen transition is reduced.

The script engine 212 is an example of a script execution unit. The browser engine 211 is an example of a display control unit. The network engine 213 is an example of a transmission unit. The network engine 213 is also an example of a receiving unit.

Although an example in which the main functions of the information processing system 1 are implemented by the information processing apparatus 10, the terminal apparatus 20 may have the functions of the information processing apparatus 10.

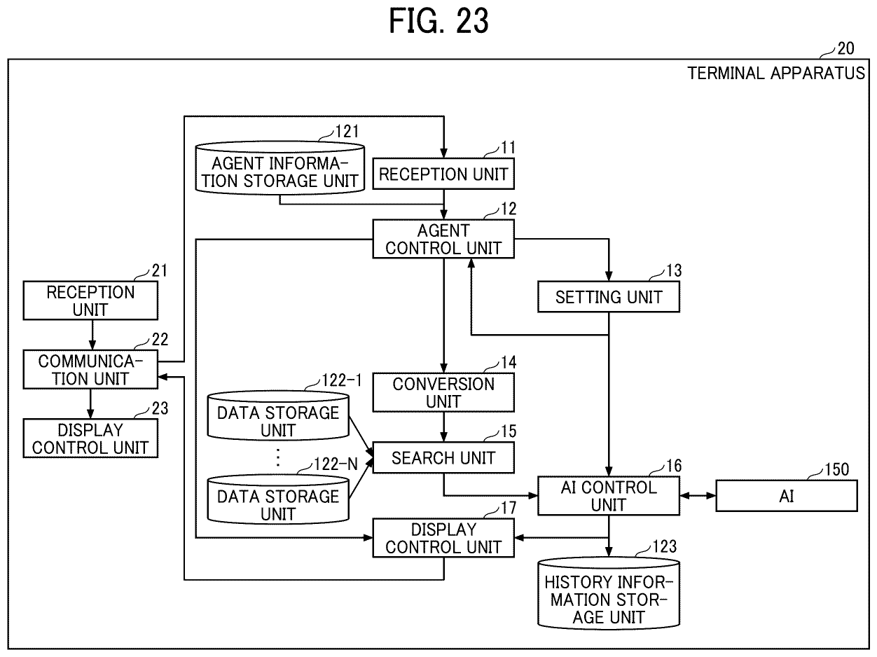

FIG. 23 is a block diagram illustrating a functional configuration of the terminal apparatus 20 having the functions of the information processing apparatus 10. In FIG. 23, identical or similar reference signs are given to elements similar to those illustrated in FIG. 4, and redundant descriptions thereof are omitted unless otherwise required. The functional units illustrated in FIG. 23 have functions similar to those of the functional units in FIG. 4 as described above, and execute processing similar to that illustrated in the sequence diagrams of FIGS. 7 and 14. In FIG. 23, the functions of the information processing apparatus 10 in the above embodiments are implemented by processing executed by the CPU of the terminal apparatus 20 according to one or more programs installed in the terminal apparatus 20.

Neither the information processing apparatus 10 nor the terminal apparatus 20 necessarily has all of the functions illustrated in FIG. 4 (or FIG. 23); each may have some of the functions. In a case where each of the information processing apparatus 10 and the terminal apparatus 20 has some of the functions, the classification of the function group of the information processing apparatus 10 and the function group of the terminal apparatus 20 is not limited to a specific form. For example, steps S202 to S240 for identifying the suitable agent may be performed by the functional group of the terminal apparatus 20, and steps S271 to S280 for generating the final response may be performed by the functional group of the information processing apparatus 10.

The information processing apparatus 10 is not limited to a general-purpose server computer, and may be any apparatus having a communication function implemented by communication circuitry. The information processing apparatus 10 may be, for example, an output device such as a projector (PJ), an interactive whiteboard (IWB; an electronic whiteboard having a blackboard function enabling mutual communication), or digital signage, or may be a head-up display (HUD), an industrial machine, an imaging device, a sound collecting device, a medical device, a networked home appliance, a laptop personal computer (PC), a mobile phone, a smartphone, a tablet terminal, a game console, a personal digital assistant (PDA), a digital camera, a wearable PC, or a desktop PC.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a recording medium such as a compact disc read-only memory (CD-ROM) or DVD, and/or the memory of an FPGA or ASIC.

The apparatuses or devices in the above embodiments are only illustrative of one of several computing environments for implementing the one or more embodiments disclosed herein.

In some embodiments, the information processing apparatus 10 includes multiple computing devices, such as a server cluster. The multiple computing devices are configured to communicate with each other through any type of communication links, including a network or a shared memory, to perform the processes disclosed herein. The terminal apparatus 20 may also include multiple computing devices configured to communicate with each other.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The following are examples of aspects of the present disclosure.

According to a first aspect, an information processing system includes a display control unit, a reception unit, a determination unit, and a switching unit. The display control unit displays, on a screen of an application used by a user, information for identifying a first interactive AI as a dialogue partner for the user among multiple types of interactive AIs that interact with the user and have different roles. The reception unit receives input of a message to the interactive AI. The determination unit determines whether a second interactive AI that can output a response more appropriate than a response of the first interactive AI to the message is present among the multiple types of interactive AIs based on the message and application information of the application. The switching unit switches the dialogue partner to the second interactive AI based on a determination that the second interactive AI is present. The display control unit displays an identifiable indication of a switch of the dialogue partner.

According to a second aspect, in the information processing system of the first aspect, the display control unit causes an interaction between the user and the interactive AI to be displayed in a partial area of the screen of the application.

According to a third aspect, in the information processing system of the first or second aspect, the display control unit causes one or more second interactive AIs to be displayed as selectable, based on a determination that the one or more second interactive AIs are present.

According to a fourth aspect, in the information processing system of the first to third aspects, a prompt to be transmitted to the interactive AI to generate a response to the message received by the reception unit differs among the multiple types of interactive AIs.

According to a fifth aspect, in the information processing system of the fourth aspect, a source from which document data to be included in the prompt is acquired differs among the multiple types of interactive AIs.

According to a sixth aspect, in the information processing system of the first to fifth aspects, the determination unit determines whether the second interactive AI is present based on type identification information for identifying a type of the application or application identification information for identifying the application.

According to a seventh aspect, in the information processing system of any one of the first to sixth aspects, the determination unit determines whether the second interactive AI is present that can output the response more appropriate than the response of the first interactive AI, in consideration of the application information.

According to an eighth aspect, in the information processing system of any one of the first to seventh aspects, the determination unit determines whether the second interactive AI is present that can output the response more appropriate than the response of the first interactive AI and that is related to the application information.

According to a ninth aspect, in the information processing system of any one of the first to seventh aspects, the display control unit causes information for identifying the second interactive AI to be displayed in response to the switch of the dialogue partner.

According to a tenth aspect, in the information processing system of any one of the first to eighth aspects, the display control unit causes a message indicating the switch of the dialogue partner for the user, in response to the switch of the dialogue partner.

According to an eleventh aspect, an information processing apparatus includes a display control unit, a reception unit, a determination unit, and a switching unit. The display control unit causes information to be displayed on a screen of an application used by a user, the information for identifying a first interactive AI as a dialogue partner for the user among multiple types of interactive Als that interact with the user and have different roles. The reception unit receives input of a message to the interactive AI. The determination unit determines whether a second interactive AI that can output a response more appropriate than a response of the first interactive AI to the message is present among the multiple types of interactive AIs based on the message and application information of the application. The switching unit switches the dialogue partner to the second interactive AI based on a determination that the second interactive AI is present. The display control unit transmits display data to cause an identifiable indication of a switch of the dialogue partner to be displayed.

According to a twelfth aspect, an information processing method executed by a computer includes a first display control procedure, a reception procedure, a determination procedure, a switching procedure, and a second display control procedure. The first display control procedure includes causing information to be displayed on a screen of an application used by a user, the information for identifying a first interactive AI as a dialogue partner for the user among multiple types of interactive AIs that interact with the user and have different roles. The reception procedure includes receiving input of a message to the interactive AI. The determination procedure includes determining whether a second interactive AI that can output a response more appropriate than a response of the first interactive AI to the message is present among the multiple types of interactive AIs based on the message and application information of the application. The switching procedure includes switching the dialogue partner to the second interactive AI based on a determination that the second interactive AI is present. The second display control procedure includes causing an identifiable indication of the switching of the dialogue partner to be displayed.

According to a thirteenth aspect, a program for causing a computer to execute a first display control procedure, a reception procedure, a determination procedure, a switching procedure, and a second display control procedure. The first display control procedure includes causing information to be displayed on a screen of an application used by a user, the information for identifying a first interactive AI as a dialogue partner for the user among multiple types of interactive AIs that interact with the user and have different roles. The reception procedure includes receiving input of a message to the interactive AI. The determination procedure includes determining whether a second interactive AI that can output a response more appropriate than a response of the first interactive AI to the message is present among the multiple types of interactive AIs based on the message and application information of the application. The switching procedure includes switching the dialogue partner to the second interactive AI based on a determination that the second interactive AI is present. The second display control procedure includes causing an identifiable indication of a switch of the dialogue partner to be displayed.

According to a fourteenth aspect, an information processing system includes a display control unit, a reception unit, a determination unit, and a switching unit. The display control unit displays, on a screen of an application used by a user, information for identifying a first interactive AI as a dialogue partner for the user among multiple types of interactive AIs that interact with the user and have different roles. The reception unit receives input of a message to the interactive AI. The determination unit determines whether a second interactive AI that can output a response more appropriate than a response of the first interactive AI to the message is present among the multiple types of interactive AIs based on the message and application information of the application. The switching unit switches the dialogue partner to the second interactive AI based on a determination that the second interactive AI is present. The display control unit causes an identifiable indication of a switch of the dialogue partner to be displayed. The display control unit transmits to a terminal apparatus web content data for displaying a first web page and a second web page. The first web page presents a screen for receiving the input of the message from the user and displays information for identifying the first interactive AI. The second web page displays the identifiable indication of the switch of the dialogue partner. The web content data includes a script for causing the terminal apparatus to execute at least a process for transmitting the message input on the first web page to an information processing apparatus, and a process for displaying the second web page that presents a screen indicating the switch of the dialogue partner to the second interactive AI. When the reception unit receives an HTTP request that is transmitted from the terminal apparatus executing the script and that includes the message input on the first web page displayed on the terminal apparatus based on the web content data, the determination unit determines whether the second interactive AI that can output the response more appropriate than the response of the first interactive AI to the message is present among the multiple types of interactive AIs based on the message and the application information. When the determination unit determines that the second interactive AI is present, the display control unit transmits to the terminal apparatus an HTTP response including information for displaying the identifiable indication of the switch of the dialogue partner, as a response to the HTTP request.

According to a fifteenth aspect, a terminal apparatus includes a display control unit, a reception unit, a determination unit, and a switching unit. The display control unit displays, on a screen of an application used by a user, information for identifying a first interactive AI as a dialogue partner for the user among multiple types of interactive AIs that interact with the user and have different roles. The reception unit receives input of a message to the interactive AI. The determination unit determines whether a second interactive AI that can output a response more appropriate than a response of the first interactive AI to the message is present among the multiple types of interactive AIs based on the message and application information of the application. The switching unit switches the dialogue partner to the second interactive AI based on a determination that the second interactive AI is present. The display control unit displays an identifiable indication of the switch of the dialogue partner.

According to a sixteenth aspect, a system including an information processing apparatus and a terminal apparatus. The information processing apparatus includes a display control unit, a reception unit, a determination unit, and a switching unit. The display control unit causes information to be displayed on a screen of an application used by a user, the information for identifying a first interactive AI as a dialogue partner for the user among multiple types of interactive AIs that interact with the user and have different roles. The reception unit receives input of a message to the interactive AI. The determination unit determines whether a second interactive AI that can output a response more appropriate than a response of the first interactive AI to the message is present among the multiple types of interactive AIs based on the message and application information of the application. The switching unit switches the dialogue partner to the second interactive AI based on a determination that the second interactive AI is present. The display control unit causes an identifiable indication of the switch of the dialogue partner to be displayed. The display control unit transmits to the terminal apparatus web content data for displaying a first web page and a second web page. The first web page presents a screen for receiving the input of the message from the user and displays information for identifying the first interactive AI. The second web page displays the identifiable indication of the switch of the dialogue partner. The web content data includes a script for causing the terminal apparatus to execute at least a process for transmitting the message input on the first web page to the information processing apparatus, and a process for displaying the second web page that presents a screen indicating the switch of the dialogue partner to the second interactive AI. When the reception unit receives an HTTP request that is transmitted from the terminal apparatus executing the script and that includes the message input on the first web page displayed on the terminal apparatus based on the web content data, the determination unit determines whether the second interactive AI that can output the response more appropriate than the response of the first interactive AI to the message is present among the multiple types of interactive AIs based on the message and the application information. When the determination unit determines that the second interactive AI is present, the display control unit transmits to the terminal apparatus an HTTP response including information for displaying the identifiable indication of the switch of the dialogue partner, as a response to the HTTP request. The terminal apparatus includes a script execution unit, a display control unit, a transmission unit, and a receiving unit. The script execution unit executes the script. The display control unit displays the first web page based on the executed script. The transmission unit transmits the HTTP request including the message input on the first web page to the information processing apparatus. The receiving unit receives the HTTP response including the information for displaying the identifiable indication of the switch of the dialogue partner. Based on the executed script, the display control unit displays the second web page that presents the screen indicating the identifiable indication of the switch of the dialogue partner.

1. An information processing system, comprising:
an information processing apparatus; and
a terminal apparatus,
the information processing apparatus including first circuitry configured to:
execute at least one of multiple types of interactive artificial intelligences (AIs) that interact with a user and have different roles;
cause information to be displayed on a screen of an application used by the user, the information for identifying a first interactive AI as a dialogue partner for the user among the multiple types of interactive AIs;
receive input of a message to the first interactive AI;
determine whether a second interactive AI that outputs a response more appropriate than a response of the first interactive AI to the message is present among the multiple types of interactive AIs based on the message and application information of the application;
switch the dialogue partner to the second interactive AI based on a determination that the second interactive AI is present;
cause an indication of the switch to be displayed;
transmit to the terminal apparatus web content data for displaying a first web page and a second web page, the first web page presenting a screen for receiving the input of the message from the user and displaying the information for identifying the first interactive AI, the second web page displaying the indication of the switch, the web content data including a script for causing the terminal apparatus to execute at least:
a process for transmitting the message input on the first web page to the information processing apparatus; and
a process for displaying the second web page presenting a screen indicating the switch;
determine whether the second interactive AI is present in response to a HyperText Transfer Protocol (HTTP) request, the HTTP request being transmitted from the terminal apparatus executing the script and including the message input on the first web page displayed on the terminal apparatus based on the web content data; and
transmit to the terminal apparatus an HTTP response including information for displaying the indication of the switch, as a response to the HTTP request, based on a determination that the second interactive AI is present,
the terminal apparatus including second circuitry configured to:
execute the script;
display the first web page based on the executed script;
transmit the HTTP request including the message input on the first web page to the information processing apparatus;
receive the HTTP response including the information for displaying the indication of the switch; and
display the second web page presenting the screen indicating the indication of the switch, based on the executed script.

2. The information processing system according to claim 1, wherein the first circuitry is configured to cause an interaction between the user and the at least one of the multiple types of interactive AIs to be displayed in a partial area of the screen of the application.

3. The information processing system according to claim 1, wherein the first circuitry is configured to cause one or more second interactive AIs, including the second interactive AI, to be displayed as selectable, based on a determination that the one or more second interactive Als are present.

4. The information processing system according to claim 1, wherein a prompt to be transmitted to the at least one of the multiple types of interactive AIs to generate a response to the received message differs among the multiple types of interactive AIs.

5. The information processing system according to claim 4, wherein a source from which document data to be included in the prompt is acquired differs among the multiple types of interactive AIs.

6. The information processing system according to claim 1, wherein the first circuitry is configured to determine whether the second interactive AI is present based on type identification information for identifying a type of the application or application identification information for identifying the application.

7. The information processing system according to claim 1, wherein the first circuitry is configured to determine whether the second interactive AI is present in consideration of the application information.

8. The information processing system according to claim 1, wherein the first circuitry is configured to determine whether the second interactive AI related to the application information is present.

9. The information processing system according to claim 1, wherein the first circuitry is configured to cause information for identifying the second interactive AI to be displayed in response to the switch.

10. The information processing system according to claim 1, wherein the first circuitry is configured to cause a message indicating the switch of the dialogue partner for the user, in response to the switch.

11. An information processing method, comprising:
causing information to be displayed on a screen of an application used by a user, the information for identifying a first interactive AI as a dialogue partner for the user among multiple types of interactive AIs that interact with the user and have different roles;
receiving input of a message to the first interactive AI;
determining whether a second interactive AI that outputs a response more appropriate than a response of the first interactive AI to the message is present among the multiple types of interactive AIs based on the message and application information of the application;
switching the dialogue partner to the second interactive AI based on a determination that the second interactive AI is present;
causing an indication of the switching to be displayed;
transmitting to a terminal apparatus web content data for displaying a first web page and a second web page, the first web page presenting a screen for receiving the input of the message from the user and displaying the information for identifying the first interactive AI, the second web page displaying the indication of the switching, the web content data including a script for causing the terminal apparatus to execute at least:
a process for transmitting the message input on the first web page to the information processing apparatus; and
a process for displaying the second web page presenting a screen indicating the switching;
determining whether the second interactive AI is present in response to an HTTP request, the HTTP request being transmitted from the terminal apparatus executing the script and including the message input on the first web page displayed on the terminal apparatus based on the web content data; and
transmitting to the terminal apparatus an HTTP response including information for displaying the indication of the switching, as a response to the HTTP request, based on a determination that the second interactive AI is present.

12. A terminal apparatus, comprising circuitry configured to:
display, on a screen of an application used by a user, information for identifying a first interactive AI as a dialogue partner for the user among multiple types of interactive AIs that interact with the user and have different roles;
receive input of a message to the first interactive AI;
determine whether a second interactive AI that outputs a response more appropriate than a response of the first interactive AI to the message is present among the multiple types of interactive AIs based on the message and application information of the application;
switch the dialogue partner to the second interactive AI based on a determination that the second interactive AI is present; and
display an indication of the switch.
